(19) United States
(12) Patent Application Publication
(10) Pub. No.: US 2006/0222569 A1
(43) Pub. Date: Oct. 5, 2006

(54) Device and method for the preparation of analyte comprising liquids

(76) Inventors: Roland Barten, Marburg (DE); Jurgen Krause, Erlangen (DE); Hans Kosak, Bonn (DE)

Correspondence Address: KANESAKA BERNER AND PARTNERS LLP, SUITE 300, 1700 DIAGONAL RD, ALEXANDRIA, VA, 22314-2848, US

(21) Appl. No.: 10/553,999

(22) PCT Filed: Apr. 19, 2004
(86) PCT No.: PCT/EP04/04125

§ 371 Date: Dec. 30, 2005

(30) Foreign Application Priority Data
Apr. 25, 2003 (DE) 10319045.7

(51) Int. Cl. B01L 3/00

(52) U.S. Cl. 422/100; 422/103

(57) ABSTRACT

The present invention relates to a device, a kit and a method for the contamination-free preparation of analyte, in particular biopolymer comprising liquids. The device comprises wo chambers (2, 3) having a reversibly changeable volume.

The present invention relates to a device and a method for the contamination-free preparation of analyte, in particular biopolymer comprising liquids.

The detection of biopolymers, such as DNA, RNA, proteins and the like, is constantly becoming more important, especially in the medicinal diagnosis and environmental analysis. Biopolymers often exist in samples obtained from a patient, such as blood samples, in a form that is unsuitable for their direct detection. Therefore, a sample preparation is necessary that makes biopolymers accessible for analysis. Due to sample preparation it is for instance possible to separate biopolymers from substances, that otherwise would interfere with the detection of biopolymers. Due to the preparation of the sample it is, furthermore, possible to release biopolymers from cells by lysis or to concentrate biopolymers from diluted solutions and, therefore, make the biopolymers accessible for analysis. Until now, methods for sample preparation have required the performance of a multitude of manual steps. These methods, therefore, required highly skilled personnel to assure that they are reliably carried out. Thus, the detection of biopolymers has been time consuming and expensive. Furthermore, it was often not possible during manual sample preparation to prevent contamination of the sample. Moreover, when carrying out the standard methods for sample preparation a release of hazardous material, such as viruses and bacteria into the environment cannot be excluded, which can lead in a laboratory environment to cross-contamination and false positive results.

EP 0 381 501 B1 discloses a device (a cuvette) for the amplification of nucleic acids and the detection of the amplified products. Initially the sample is pipetted into a reaction chamber for amplification. Afterwards, the solution is transferred to a detection chamber. During the transfer no contact of the sample with the environment is possible, therefore, contaminations can be excluded. However, the device does not provide means for an automated sample preparation before the amplification step, which is essential in analysis, e.g. by PCR amplification reactions, of a sample obtained from a patient. A separate step for the sample preparation is required upstream of the disclosed method to facilitate the later PCR. Thus, this method and device does not avoid cross-contamination or prevents the release of hazardous material.

EP 0 687 502 B1 discloses a method and a device for preparing nucleic acids from a sample. In the apparatus a first and a second chamber are provided. The sample preparation is carried out in the first chamber and the amplification of the nucleic acids in the second chamber. The solution is transferred from one chamber into the next through a channel containing a three-way distributing element, such as a three-way stopcock, which serves to connect the first and the second reaction chamber and a waste chamber. The transfer of liquids between reaction chambers is carried out by opening appropriate valves and by applying negative pressure, preferably vacuum to the chambers. Thus, the system is not entirely closed towards the environment since an external vacuum source has to be attached, which increases the risk of releasing DNA from the sample into the environment and, thus, the risk of cross-contamination. In addition the device comprises vacuum operated valves and three-way distributing elements, which are expensive to manufacture and make the device less suitable as a single-use device, which are often required for analytical purposes in the medical field.

U.S. Pat. No. 6,440,725 B1 discloses a device for the preparation of nucleic acid containing probes. In a first step the sample is sonicated in a chamber to lyse the cells containing the nucleic acids. To separate the cell fragments the solution is subsequently pressed through a filter. A disadvantage of the disclosed method is that the filter, which has to have a small pore size in order to retain the cellular debris is prone to clog during the preparation step.

WO 00/75623 A1 discloses a device and a method for the extraction of biomolecules from a liquid. The disclosed device is designed to prevent clogging. It provides, a syringe containing a filter material, the porosity of which is adjusted, so that it is not clogged by cell fragments. The filter material is furthermore designed to bind DNA, while the sample solution is passed through. However, the disclosed device has several disadvantages. It is still possible, that the filter can clog, and it is not possible to lyse the cells contained in the sample solution with the disclosed device and, therefore, lysis has to be carried out in a separate upstream step. Again the transfer of the lysed cells into the disclosed device is prone to cause contamination or release of hazardous materials.

U.S. Pat. No. 6,197,595 B1 and the corresponding US patent application 2001/0036672 A1 relate to a method for handling a sample in a miniaturized fluidic system. The miniaturized fluidic system comprises at least a first and a second chamber, that are connected by a channel to form a fluid connection. In the fluid connection at least a first and a second controllable valve is arrayed. To move the liquid in the fluidic system a positive and/or negative pressure source is provided. Recurring positive and/or negative pressure can be exerted on the liquid by a suitable control of the valves, so that the liquid can be moved from one chamber to another chamber. A membrane pump, which is connect to all chambers, is used as the positive and/or negative pressure source. Alternative means disclosed comprise, a gas overpressure device and a vacuum device. A miniaturized fluidic system as disclosed is expensive to manufacture. In addition, several controllable valves have to be provided for controlling the pressure and the flow of the liquid. Finally, because of the high positive pressure applied to the system gas comprised in the system will dissolve in the sample or analysis solutions, which is undesirable since upon lowering the pressure bubles can form in the system, which obstruct the flow of liquids in the microfluidic device. To avoid this problem a special degasing chamber is provided in the disclosed device. The movment of liquids by overpressure does not allow the accurate determination of the amount of fluid, which is moved due to the compressibility of gases. The miniaturized fluidic systems also necessitates one dedicated chamber for each reaction. The sample is carried from one chamber to the next chamber for the sequential processing steps. Providing a multitude of chambers requires lengthy and expensive manufacturing process.

EP 1 123 980 A2 discloses a system for nucleic acid analysis comprising a binding, an amplification and a detection compartment/room. The system comprises at least part of the binding room within the amplification room. The nucleic acids contained in a sample are purified by immobilizing the nucleic acids (preferably to a surface of a glass or a polystyrene capillary) and separating the impurities, then the immobilized nucleic acids are eluted, amplified and detected. The compartments/rooms are connected by a channel that is controlled by a three-way stopcock. The amplification compartment is open to the environment and, thus, does not avoid contamination of the sample or the environment efficiently. A further disadvantage of this system is that the nucleic acids contained in a sample are bound to the surface of a capillary that is a stationary phase, therefore binding, mixing with wash and elution solutions cannot be as efficient as in a system where the nucleic acids can also be bound to particles that can move freely and can, therefore, mix in a more efficient way.

One object of the present invention is to avoid the disadvantages in the art. In particular there shall be provided a device and a method that allow the reliable and automated preparation of analyte(s), in particular of biopolymer from liquids comprising this analyte(s).

Therefore, in one aspect the present invention provides a device for contamination free preparation of analyte containing sample solution (P), comprising

a first (2) and second chamber (3), which are connected by a channel (6, 8, 10),

wherein the first chamber (2) has means (4) for reversibly changing its volume, and the second chamber (3) has a reversibly changeable volume,

wherein a connector (7, 9), which is provided with a means of flow regulation, is connected to the channel (6, 8, 10) or one of the chambers (2, 3) for loading of a sample solution into the first (2) or the second chamber (3).

The term “contamination free” within the meaning of the invention refers to the fact that the device is fluidically closed towards its exterior so that once the sample solution is loaded through the connector (7, 9) into the first or the second chamber, all process steps for the preparation of the analyte occur within a closed system that neither allows any externally present analytes to enter the device nor any analytes from within the device to contaminate other samples. Thus, the device of the present invention minimizes the contamination of the environment as well as of the sample. The avoidance of contamination is essential in many medical settings, however, it is particular important if the analyte to be analyzed is DNA and if the analysis is carried out by the polymerase chain reaction (PCR). PCR is such a sensitive method that any contamination, such as traces of DNA or DNA comprising cell and/or material i.e. g. hair or skin flakes that can originate from the operator of the device or from other samples stored nearby can easily lead to false positive results. Therefore, it is important to prevent that analytes foreign to the sample are introduced into the system and vice versa that analytes from within the sample are released into the environment where they could potentially contaminate other samples.

The term “means of flow regulation” as used herein refers to any device that allows to restrict the flow between two chambers, within a channel or between the exterior of the device and the interior in either one direction or both directions. Examples include without limitation valves of various forms known to the skilled practitioner, including ball valves, membrane valves, and the like, septums and stop cocks. If the device comprises only one connector, which connects the interior of the device to the exterior than the connector will preferably be capable to control the flow in two directions, i.e. after application of the sample through the connector into either the first or the second chamber it will prevent the flow out of the device during the preparation procedure and after the analyte has been prepared it will allow the flow of the analyte out of the device. If the device comprises two or more connectors preferably one connector is used for loading the sample and another for dislodging the analyte. The connector used for loading the sample will in this embodiment preferably be a one-way valve, unidirectional restriction valve or a septum. The connector through which the analyte is dislodged will preferably also be provided with a means of flow regulation. In the embodiment using a septum, it is envisioned that the sample is injected into the device by piercing the septum with a needle and that the needle attached to the syringe is either left in the device to prevent the flow out of the device during the preparation step or removed.

The term “channel” refers to any fluidic connection between the two chambers. Preferably a channel has an essentially round cross-section and preferably has a diameter which is smaller than the diameter of the chamber. Preferably the area of the cross section of the channel is at least ½, more preferably at least ⅕ more preferably 1/10 and even more preferably 1/50 smaller than the area of the cross-section of the chamber. The opening of the channel towards the respective chamber is preferentially located in the vicinity of the end of the chamber opposite the means for reversibly changing the volume and most preferably at the end of the chamber, thus allowing to dislodge all liquid from the chamber through the channel. In a preferred embodiments the channel (6, 8, 10) between chamber (2) and chamber (3) has a diameter of between 10 μm and 1000 μm, preferably between 100 μm and 800 μm and even more preferably between 400 μm and 600 μm. The small diameter of the channel (6, 8, 10) facilitates break up of cell aggregates shearing of genomic DNA and the solubilization of sample when it is pumped back and forth between chamber (2) and chamber (3).

A “means for reversible changing the volume” allows to exert a negative or positive pressure within the chamber and can be without limitation a flexible membrane attached to the end of the chamber, a deformable chamber or a deformable part of the chamber or a means which can be moved within the chamber. To allow the change of the volume within the chamber and, thus, to draw in or push out liquid from the chamber it is necessary that the means for reversible changing the volume can be moved and/or deformed by applying force. The means for applying force can be part of the device of the present invention or can be located outside the device, preferably this means are provided outside the device in an automated form.

A “chamber having a reversibly changeable volume” is similarly provided with a flexible membrane, a deformable chamber like, for example, a rubber bulb or a deformable part of the chamber or a means, which can be moved within the chamber, however, it does not comprise a means for applying force nor is it connected to such a means. If such a means is provided the “chamber having a reversible changeable volume” becomes a chamber with a means for reversibly changing the volume. The size of the chamber(s) is(are) not particularly limited. They typically hold between 10 μl and 50 ml preferably between 30 μl and 2 ml. The chambers within a device can have various different volumes as required by the specific preparation method.

In the device of the present invention liquids are transported from one chamber to the next by simply changing the volumes of the chamber(s). Moreover, liquids can repeatedly be moved back and forth between chambers, in particular the first and the second chamber by reversibly changing the volumes of the chambers. In contrast to the positive and/or negative pressure devices known from the prior art, the chambers of the device of the present invention are designed in such that their volume is changeable. By appropriately extending or reducing the volumes of the chambers an exact movement of the liquid within the system is possible without great effort. This in particular avoids the unwanted process of changing the solubility of gas in the sample liquid, which can lead to bubble formation. Thus, special degasing chambers are not necessary. The device according to the invention requires only a few chambers. One chamber can be used more than once, e.g. to carry out different reactions. Furthermore, the chambers can be adjusted to a particular maximal volume depending on the reaction to be carried out. The design of the device prevents contamination of the sample and the environment to the greatest possible extent and allows the automatic performance of the sample preparation step and, if desired also of analyte amplification and/or detection.

It is preferred that the device according to the invention does not include filters in particular between chambers (2) and (3) or only large poor size filters. Thus no clogging can occur during sample preparation. A reliable automated sample preparation is, therefore, provided.

In a preferred embodiment of the device of the present invention, in particular chambers (2, 3) and the channel (6, 8, 10) or the complete device is designed as a single use device, i.e. after the analyte is prepared the device can be thrown away or in cases in which the device comprises additional functionalities, like, for example, an analyte amplification compartment and/or an analyte detection compartment, the whole device including these additional functionalities can be thrown away. The single use devices of the present invention are preferentially made out of relatively cheap materials like, for example, polypropylene, polyethylene, polyacrylate, polyvinylchloride, polycarbonate or polystyrene or a mixture thereof, which are easy to mold or machine into different shapes and are amenable to, for example, injection molding. Different parts of the device can be manufactured of different materials as might be required by temperature or solvent exposure. In addition single use devices will preferentially not comprise electrically operated pumps or electrically operated valves but those functionalities can be supplied from the outside of the device to keep the cost of the single use device low. The design of the device of the present invention as a single use device is particularly advantageous, because after the sample preparation is completed a release of hazardous materials potentially left in the device, such as viruses, bacteria and other germs, can be prevented. Moreover, the single use device can be disposed as a whole, e.g. by combustion.

It is further preferred, that no means of flow regulation is provided between the first (2) and the second chamber (3). In this embodiment the flow between the two chambers is controlled by the movement of the means (4) of reversibly changing the volume. If the means is moved towards the end of the chamber opposite the means then the liquid will flow through the channel (6, 8, 10) into the other chamber and vice versa. If the means for reversibly changing the volume is moved in the opposite direction, i.e. pulled out of the chamber, than the liquid flow will be into the chamber. Thus, the need for elaborate and expensive valves, which control the flow between the first chamber (2) and the second chamber (3) is avoided.

As outlined above the fluid flow between the two chambers can be controlled by pushing in and pulling out the means (4) for reversibly changing the volume, while the other chamber just passively adapts to this movement due to the principal of communicating tubes. However, in a preferred embodiment the second chamber (3) of the device is also provided with a means for reversibly changing the volume (5). This will allow to control the flow of fluids either by pushing in and pulling out the means (4) for reversibly changing the volume of the first chamber (2), by pushing in and pulling out the means for reversibly changing the volume (5) of the second chamber (3), by alternately pushing in the means (4, 5) for reversibly changing the volume of the first (2) and second chamber (3) or by alternately pulling out the means (4, 5) for reversibly changing the volume of the first (2) and second chamber (3). If the flow of the fluid between the two chambers (2, 3) has to be affected more than once any combination of the above ways of directing the flow of fluids can be applied subsequently.

In a preferred embodiment of the device of the present invention the first connector (7) is connected either to a first channel (6), which extends from a point in the vicinity of an end, preferably from the end of the first chamber (2) opposite the first means (4) for reversibly changing the volume of the first chamber (2) or directly to the first chamber (2). This connector is provided to load the sample solution into the first chamber (2) or the second chamber (3), preferably the first chamber (2). If the sample is loaded into the first chamber (2) the movement of the means for reversibly changing the volume or the reversible changeable volume (5) of the second chamber (3) is restricted, while the means (4) for reversibly changing the volume in the first chamber (1) is either actively pulled out to suck in the sample (P) through the connector (7) or passively pushed out by the force of the sample fluid being injected into the first chamber (2). Alternatively, if the connector (7) is connected to a first channel (6), which also communicates with the second chamber (3) it is also possible to load the sample into the second chamber (3) by restricting the movement of the means (4) for reversibly changing the volume in the first chamber (2). This is another example of how the fluid flow into the device and/or into the chambers as well as between the chambers can be controlled without a means for regulating the flow between the first (2) and the second chamber (3). It should be pointed out that it is not required for the regulation of the flow that the means, which is restricted in its movement, is located at the end of the chamber opposite the means, i.e. that the chamber is empty. It is possible that the chamber is already filled with liquid, which, however, will essentially not mix (disregarding diffusion phenomenons, which might occur at the interphase) with the sample injected or drawn into the other chamber unless the restriction of the means is released to allow the means to be moved again, either passively or actively.

As pointed out above in a preferred embodiment the device of the present invention comprises two or more connectors and preferably such a second connector (9) is connected to a second channel (8), which extends from an end of the second chamber (3) opposite the second means (5) for reversibly changing the volume or to the second chamber (3). The second connector (9) enables dislodging of the prepared sample through the second connector (9) in order to prevent a contamination of the prepared analyte at the first connector (7), e.g. by residual contamination from sample loading. The second connector (9) will in a preferred embodiment also be provided with a means of controlling the flow in order to prevent the contamination of the exterior of the device with the analyte or vice versa the contamination of the sample from the exterior. However, in some embodiments it is also possible that the second connector (9) is in turn connected to an additional chamber like, for example, a detachable syringe, or an additional device like, for example, an amplification device and/or an analytical device or additional functionalities integrated into the device of the present invention, i.e. amplification and/or detection functionalities. Then the flow of the sample or of any liquid passed between the first (2) and the second chambers (3) during the preparation of the analyte through the second connector (9) can be prevented without the provision of a means of controlling the flow, e.g. a valve, by restricting the movement of liquid in the additional devices connected via the connector (9) to the device of the present invention or by restricting the movement of the means of flow regulation, e.g. a piston in the additional chamber, e.g. by locking the plunger of the syringe attached to the connector (9). Preferably the prepared analyte is dislodged through the second connector (9).

In a further embodiment of the device of the present invention a second channel (8) extends from a point in the vicinity of an end, preferably from the end of the second cylinder opposite the second means (5) for reversibly changing the volume, wherein the channel (8) is connected to the first channel (6) or to the first chamber (2).

It is also envisioned by the present inventors that the device comprises at least one further chamber (15, 20, 21), which is (are) provided with a reversibly changeable volume, preferably with a means for reversibly changing the volume and wherein that chamber(s) is (are) connected with the first (2) and/or second chamber (3) through the first (6) or second channel (8) or through a further channel(s) (17, 24, 25), which is (are) connected to a third channel (10) connecting the first (6) and second channel (8). These further chambers preferably comprise reagents, which are needed for the preparation of the analyte and/or waste compartments, which can hold the discarded fluids like, for example, sample solution depleted of analyte, lysis or washing solutions. Depending on the respective analyte to be isolated and the purification steps to be employed the device comprises one, preferably two, more preferably three or even more additional chambers. The device allows the accommodation of many different purification protocols and accordingly someone of skill in the art could determine the number of chambers needed for a given protocol without undue burden.

In a particular preferred embodiment no means of flow regulation is provided between the first (2) and second chamber (3) and no means of flow regulation is provided between two or more further chamber(s) (15, 20, 21), i.e. preferably no means of flow regulation is provided between three further chambers, more preferably four further chambers, more preferably five further chambers. It is even more preferred that a means of flow regulation is provided between chambers (2) and (3) on the one side and the further chambers (15, 20, 21). This single means of flow regulation allows to uncouple the two chambers (2) and (3) from the rest of the system in such that reactions can be carried out in chambers (2) and (3) even under increased pressure without causing any mixing of the reagents comprised in the further chambers (15, 20, 21). As outlined above the flow between the chambers is preferably controlled by restricting the movement of the means for reversibly changing the volume. Thus, if the device comprises three, four, five, six, seven, eight or more further chambers and a flow of liquids is desired, for example, from one of the further chambers (15, 20, 21) the first (2) and/or the second chamber (3), then the movement of the means (4, 5) for reversibly changing the volume will be restricted in all other chambers. In this case pulling the means (4, 5) for reversibly changing the volume in the first (2) and second chamber (3) will cause a flow from the further chamber into the first (2) or second chamber (3) or pushing the means (4, 5) for reversibly changing the volume into one of the further chambers (15, 20, 21) will cause a flow into the first (2) or second chamber (3) without any flow into the other chambers (again disregarding diffusion phenomenons, which might occur at the interphase). If the movement of liquid between the first (2) and the third chamber is to be achieved, for example, to dislodge sample liquid depleted of analyte into the waste, the movement of the second means for reversible changing the volume will be restricted as well as the movement of such means in a fourth or any additional chamber, while the means for reversible changing the volume in the first (2) and third chamber, e.g. the waste chamber, are moved either passively or actively in or out as outlined above. Thus, the device of the present invention allows in a preferred embodiment to hold a multitude of reagents in different chambers and to selectively and sequentially apply those reagents to the sample to be prepared without the provision of an elaborate and expensive valve system to control the fluid flow between the multitude of chambers. Again as pointed out above it is preferred that one means for restricting the flow between chambers (2, 3, 15, 20, 21) is provided between chambers (2, 3), wherein the analyte preparation is carried out and chambers (15, 20, 21), wherein reagents are stored.

In a further embodiment and in particular in an embodiment in which no means of flow regulation is provided at least between two, preferably three, four, five, etc. or all further chambers (15, 20, 21), and wherein these chambers preferably hold reagents required for sample preparation, it is preferred that the length and diameter of the channels between at least one, preferably two, three, four, five, etc. or all further chambers is such that the volume of the channel is larger than the compressible volume of the system. The “compressible volume of the system” within the meaning of the present invention is the volume reduction in the operational, i.e. fluid filled preferably fluid flushed and fluid filled device, of the present invention once positive or negative force is applied to the system due to the movement of a means for reversibly changing the volume, preferentially while the movement of all other means for reversibly changing the volume is restricted and/or means for flow regulation provided in the connectors (7, 9) are closed. The amount of the compressible volume is determined by several factors including the total liquid volume in the system, the compressibility of the liquid(s) filling the system, the amount of gases remaining in the system after flushing and filling of the device, the flexibility of the materials making up the chambers, channels, plungers and other building blocks of the device and the pressure applied to the system. The skilled person is able to determine without undue burden the compressible volume of a given fluid filled device. The selection of the volume of the channel between two further chambers larger then the compressible volume of the system reduces the mixing of fluids between the two further chambers (15, 20, 21) once pressure is applied to one of them and/or to the system.

In a typically embodiment of the device of the present invention mixing can be prevented, if channels are provided with a volume of between about 5×10⁻⁴ and about 5×10⁻³ of the total volume, preferably between about 1×10⁻³ and about 3×10⁻³ of the total volume and even more preferably about 2×10⁻³ of the total volume. In a typical fluid filled device of the present invention with a total fluid volume of about 5500 μl the volume of the channel(s) is(are) chosen to be at least 3 μl, preferably about 10 μl. If the volume of the system and, thus its compressibility increase, the volume of the channel has to increase proportionally. Furthermore the length to diameter ratio of these channels is preferably at least 10:1 and more preferably 50:1. They can be placed, for example, in a meandering way between the further chambers to accommodate a sufficient length in a compact device. The maximal pressure applied to a device of the present invention, which also determines the compressible volume is preferably between 0.05 to 0.5 MPa, more preferably between 0.2 and 0.4 MPa and even more preferably about 0.3 MPa.

Since the means for reversibly changing the volume can be actively or passively pulled out or pushed in it is possible that the means are pushed or pulled out of the device during the preparation procedure, therefore, in one embodiment at least one, preferably at least two means (4, 5, 14, 22, 23) for reversibly changing the volume and/or means (5) movable therein, i.e. if the chamber volume is only passively enlarged or decreased following the movement of means for reversibly changing the volume in another chamber, are mechanically secured against being completely pulled and/or pushed out of the chamber(s). Such mechanical securing means can take on any number of art known forms and include without limitations, ridges, bulged structures, constrictions, protruding pins, notch engaging structures and the like. Preferably, this securing means are positioned at the end of the chamber opposite to the end at which the channel is located.

The end of the chambers opposite the means for reversibly changing the volume can take on any form, however, it preferably has a flat or conical form. It is even more preferred that at least one of the chambers is conically tapered at the end of the chamber opposite the means (4, 5, 14, 22, 23) for reversibly changing the volume and/or movable therein. In this embodiment the opening of the respective channel (6, 8, 17, 24, 25) towards the chamber (2, 3, 15, 20, 21) is preferably at the tip of the conus. The conical form is particularly preferred for all chambers from which all liquid has to be dislodged during the preparation of the analyte, since the conical form and in particular in conjunction with the above outlined arrangement of the channel opening at the tip of the conus prevents the enclosure of residual liquid in the chamber once the means for reversibly changing the volume has been moved all the way towards the end of the chamber. The further chambers, i.e. the third, fourth, fifth or more chamber can also have a conical shape or can have a flat shape.

In a particular preferred embodiment only one chamber (2) will have a conical shape and will allow complete discharge of liquid from the chamber.

In a preferred embodiment the means for changing the volume in the first (2) and/or further chamber(s) (15, 20, 21) is a piston (4, 5, 14, 22, 23) and/or the means movable in the second chamber (3) or for reversibly changing the volume in the second chamber is a piston (5). The piston will have a shape that is complementary to the chamber and will in a preferred embodiment have an essentially circular shape. The piston is capable to move through the chamber and provide a fluid tight seal between the exterior and the interior of the device. The piston can be made of any material known to be suitable to provide a fluid tight seal, however, in a preferred embodiment it is made of polypropylene, polyethylene or polyvinylchloride. The choice of material is in part determined by the analyte to be prepared and by the reagents employed to prepare that particular analyte. In some embodiments it might, therefore, be required that the piston is made of an inert material like, for example, polyvinylfluoride (PVF) or polyvinylidenfluoride (PVdF) or that at least the surface of the piston is coated with such a material, e.g. PVF or PVdF. In some embodiments of the device of the present invention, in particular when higher pressures are employed during the purification process the piston can additionally compriseo-rings made of, for example, synthetic or natural rubber, silicone, PVF, polyurethane or the like, which allow a tighter seal between the piston and the walls of the chamber. It is, however, also envisioned that the entire piston is made of such material.

If the chamber has a round shape it will typically have diameters of between 1 and 10 mm and will have a length of between 1 and 10 cm. The chambers will preferably hold a volume of between 10 μl and 10 ml, more preferably between 20 μl and 5 ml and even more preferably between 50 μl and 2 ml. Within one device different sized chambers can be combined as required by the sample preparation.

As pointed out above it is in some embodiments of the invention desirable that all liquid is dislodged from a chamber. In addition it has been pointed out above that the end of the chamber opposite the means for reversibly changing the volume can take on many different shapes. Therefore, in a preferred embodiment the piston(s) have the shape of the end of the chamber opposite to them or can accommodate this shape. It is even more preferred that the piston has a flat or conical shape or can accommodate a flat or conically shaped end of the chamber. In this respect the term “accommodate” implies that the piston originally does not have the shape of the end of the chamber but upon engaging the end of the chamber will take on its shape. To be capable of accommodating the shape of the end of the chamber the piston or at least a part of the piston facing the interior of the device has to be flexible. A large number of flexible materials are known in the art and can all equally be employed for making the piston of the present invention, however, particularly preferred materials include without limitation natural or synthetic rubber, silicone and polyurethane. If the end of the chamber has, for example, a conical shape than a piston having a round flexible part facing the end of the chamber will take on the conical shape once it is engaged with the end of the chamber. Thus, the piston will be able to push the entire liquid and any particles suspended therein out of the chamber with the result that the entire liquid is moved between the two chambers, which is advantageous for good mixing, e.g. of lysis buffer comprising the particles, in particular magnetic particles and the organic sample comprised in the sample solution.

If required it is possible that the particles are held back in the chamber, for example, by generating a magnetic field close to the end of the chamber, and that almost all liquid is removed by moving the piston into the chamber until it reaches the particles, however, preferably without displacing the particles from the chamber. The extent of the flexibility and, hence the ability to accommodate the shape of the chamber can be controlled by the choice of the material and design of the piston. A piston that comprises a non-elastic or essentially non-elastic core material like, for example, metal or hard polymers, e.g. polyacrylate, polypropylene, polyethylene or polycarbonate and an elastic coating, which contacts the walls of the chamber will be less flexible, if compared to a piston, which is made entirely of an elastic material. The thickness of the elastic coating covering the non-elastic material and the choice of the elastic material will determine the elasticity of the resulting piston and hence its ability to accommodate the shape of the end of the chamber. The elastic material can comprise a further coating with an inert material as outlined above, e.g. PVF or PVdF.

In a preferred embodiment only the pistons (4, 5) of the first (2) and the second chamber (3) and even more preferred only piston (4) of the first chamber (2) consist of an elastic material, which has or can accommodate the shape of the end of the chamber opposite to it. When the pistons (4, 5) of the first (2) and/or the second (3) chamber consist of elastic material it is further preferred that the pistons in further chambers consist of a non-elastic material or of material with a reduced elasticity, i.e. not the whole piston is made out of elastic material. This arrangement prevents the undesired inflow and outflow of liquid into the further chambers or the second chamber (3) and the further chambers when liquid is moved between the first (2) and/or the second chamber (3), which might otherwise occur, if due to the flexibility of the pistons in the further chambers liquid is pressed into the chambers when liquid is moved between chambers. This can be important, when the further chambers hold reagents like, for example, lysis, washing or elution solutions, which are only required at a later stage of the analyte preparation and which might deteriorate or become unusable upon exposure to or mixture with one of the reagents used at an earlier stage of the preparation or comprised in a further chamber.

In another embodiment of the device of the present invention at least one piston, preferably all pistons are not connected to a piston rod. In this embodiment the pistons are moved by the introduction of rods from outside the device. Albeit it is possible to provide the exterior facing side of the piston with a means which allows attachment of the rod introduced from the outside like, for example, a screw thread or a snap in device (26) it is preferred that the piston rod which is introduced from the outside is not attached to the piston itself. In this arrangement the pistons can then only be moved by pushing them into the chambers and not by pulling them out of the chambers. To control, for example, the flow back and forth between the first (2) and the second chamber (3) the piston (4) of the first chamber (2) can be pushed in and the piston (5) of the second chamber (3) can be passively moved out of the chamber (the movement of the pistons in any further chamber can be restricted). Then the piston (5) of the second chamber (3) can again be moved in, which will result in a flow of the liquid from the second (3) to the first chamber (2). Similarly liquid can be moved between any two chosen chambers. One advantage of this design is that the device can simply be placed into an automated apparatus comprising movable rods without actually connecting the pistons of the device to the automated apparatus, which would require additional manipulation, in addition the omission of rods makes the device easier to produce at a lower cost.

The cross-section of the chambers employed in the device of the present invention can take on any shape like, for example, round, triangular, square, hexagonal, it is, however, preferred that the chambers (2, 3, 15, 20, 21) have an essentially round cross-section. The chambers preferably have the same cross-section over most of the length of the chamber. In some preferred embodiments, in which the end of the chamber has a conical shape and/or in which a securing means is provided the shape of the-cross section can change at one or both ends of the chamber accordingly.

In a common embodiment of the device of the present invention the channels and chambers are permanently connected and can be assembled from one or more individually molded pieces. It is possible that this completely assembled device will be supplied ready for use including any reagent that is required by the particular preparation scheme, however, it is also possible to individually fill one or more of the chambers immediately prior to use with the respective reagents. In a further embodiment all or some chambers containing reagents are supplied separately in connectible preferably sealed chambers, which are only connected to the channels of the device prior to use. This has the advantage that each reagent in a chamber can be stored separately as required to maintain its integrity, e.g. reagents which are volatile or degradable can be stored at lower temperature, while other less sensitive reagents can be stored at room temperature. In addition it is thus possible to prepare a reagent like, for example, an enzyme solution immediately prior to use of the device and load a chamber with this freshly prepared reagent. In addition the mixing of the different reagents due to diffusion, which will occur upon prolonged storage at a slow rate even if the pistons in the chambers are not moved, can be prevented.

Thus, in a further embodiment at least one chamber (2, 3, 15, 20, 21) preferably at least the second (3) and/or one or more further chamber(s) (15, 20, 21) (e.g. two, three, four, five, six, seven, eight or more) are connectible to the channel(s) (8, 10, 17, 24, 25). The connection between the channels and the chambers has to be fluid tight to assure the later contamination free preparation of the analyte. Suitable connecting means are known in the art and comprise, for example, luer locks or a combination of spikes on the side of the channel and o-rings on the side of the chamber or vice versa. The connection between the channel and the chamber can be releasable as in the case of the luer lock or it can be permanent. Such a permanent connection once the chamber is engaged can be provided, for example, by a ledge attached to the chamber that snaps into an indention on a connection means provided next to the channel, e.g. (8), or spike (28).

In addition in a preferred embodiment the connectable chambers are designed to have a seal preventing any liquid reagent inside to discharge or be contaminated. This seal is removed either immediately prior to connecting the chamber(s) with the channel(s) or upon engaging the connecting means provided on the chamber and on the channel. Such a seal can take on any number of art known forms and can be mode of a large variety of different materials including but not limited to metal foil, e.g. aluminum foil, metal plated polymer foil, the material of the chamber, a glass bead and a polymer membrane e.g. made of polypropylene or polyethylene. In addition it is preferred that the channels (6, 8, 17, 24, 25) which are connectible to chambers are also sealed to prevent the entrance of dirt and/or contaminants into the device. In a particular preferred embodiment channels (8, 17, 24, 25) of the second chamber (3) and all further chambers (15, 20, 21) are sealed and the first chamber (2) is permanently attached to channel (6). The type of seal, which can be used to seal the channels can be identical to the seals taught above for the sealing of the chambers and comprises metal foil, polymer foil or metalized polymer foils. In the embodiment in which both the channels or at least some of the channels and at least one chamber is sealed, both seals will be ruptured upon engagement of the chamber and the channel. To this end the tip of the channel can be designed in a variety of forms comprising luer lock-form, spike or needle-like form.

In some embodiments the spike or needle will protrude chamber between 0,1 and 10 mm into the once the chamber is connected to the channel and in this embodiment the piston(s) (5, 17, 22, 23) will not be able to move all the way to the end of the chamber. In this case it is preferred that at least one chamber (2) is permanently connected to the channel (6) and, thus, comprises no protruding spike or needle. Therefore, all liquid comprised in this chamber can be discharged, which is desirable, for example, if small liquid volumes are transferred between chambers. This is often the case when the analyte purification has been completed and the analyte is comprised in a much smaller volume, which then needs to be discharged completely from chamber (2) to avoid loss of analyte.

The sealing of the chambers will allow easier shipping and storing of the different parts of the device of the present invention prior to assembly and use. To prevent the connection of a chamber to the wrong channel, i.e. to prevent a mix up of the reagent solutions, the connecting means and/or the chambers can in a further embodiment be color coded or shape coded. Such coding will allow to connect the respective chamber only to the appropriate channel.

In a preferred embodiment the axes of the chambers (2, 3, 15, 20, 21) are arranged parallel to each other. This arrangement allows providing actuation of the means for reversibly changing the volume, in particular the pistons, in the chambers from only one side of the device, which in turn simplifies the apparatus used for actuation of the means for reversibly changing the volume. In an even more preferred embodiment, the axes of at least two chambers are arranged in one plane. As outlined above it is also preferred that the means for reversibly changing the volume are actuated by an automated device into which the device of the present invention is inserted. To allow a simple design of such an automated device, wherein the actuators are all located in one section of the device, it is preferred that at least two preferably at least, three, four, five, six, seven, eight, nine, ten or more chambers are arranged on the same site of the device, preferably parallel to each other, which allows actuation from only one side.

As outlined above the device of the present invention can contain additional reagents as required by the particular preparation task. Since the analytes, which are preferably prepared using this device are comprised within organic samples, in particular within patient samples including but not limited to tissue samples, cells, bodily fluids and waste products including blood, sputum, lymph, vaginal secretion, urine, stool and lachrymal. The device comprises a liquid (L) capable of solubilizing the organic tissue in one of the chambers (2, 3, 15, 20, 21), preferably in the second chamber (3). In this respect the term “solubilizing” refers to the capability to release the analyte from the organic sample and/or stabilize it against degradation. If the analyte is comprised within a cell the solubilization involves the disruption and/or perforation of the cell, however, if the analyte is already soluble within the organic sample like, for example, a peptide hormone in the urin no disruption is required and the solubilization involves the stabilization of the analyte within the organic sample. The skilled practitioner is aware of a large variety of solubilizing liquids and is capable to choose the appropriate liquid depending on the respective organic substances to be solubilized and the analyte to be prepared. For the solubilization of cells such liquids can comprise chaotrophic reagents like guanidinium-HCl or urea, high salt solutions, enzyme solutions and/or detergents. If the analyte is, for example, DNA or RNA liquids comprising chaotrophic reagents are preferred, since they inactivate nucleases comprised in cells and tissues by denaturing them. If the analyte is, for example, a polypeptide the liquid can comprise high salt and a detergent preferably a non-ionic, e.g. Tween, which will disrupt the cell wall, without denaturing proteins. In addition this liquid can comprise further components, which are chosen depending on the analyte to be prepared like, buffers, e.g. Tris-HCl and HEPES; chelating agents, e.g. EDTA, EGTA; sugars, e.g. maltose, dextrose; protease inhibitors, e.g. PMSF, pepstatin, leupeptin, and Aprotenin; nuclease inhibitors, e.g. RNasin; protein stabilizing agents, e.g. albumin, or the like. Again the skilled artisan is aware of a large variety of reagents, which can be applies to different preparative tasks. Standard protocols for many purification tasks are disclosed in, for example, Sambrock et al.: Molecular Cloning a laboratory manual, 3^{rd} Ed. (2001), Cold Spring Horber Laboratory Press or Cusubel et al. short protocols in Molecular Biology 5^{th} Edition, (2002) John Wilty & Sons (which are both incorporated herein by reference).

In some instances it can be desirable to facilitate break up of cells or tissue and/or solubilization by sonification. This can be required, for example, if the sample comprises large tissue pieces bacterial spores or virus, which are not amenable to lysis by chemical means only or which will not lyse sufficiently fast. To facilitate sonification of the sample within the device of the present invention the device can be further provided with a section allowing coupling to a sonification device, e.g. sonification tip. For an efficient transfer of sound this section has to be made of hard material, e.g. metal or high molecular weight polymer. This section can be placed in a channel or chamber. Preferably at least a part of a chamber, preferably of chamber (2) and/or (3) is made of material capable of transferring the sound waves of the sonification device.

For some samples it might also be desirable to facilitate break up or even at a later step binding and/or elution by changing the temperature within at least one chamber, preferably chamber (2). Therefore, the device can comprise means for transferring heat and/or cold into a chamber or channel. Such device can include pieces of metal within the chambers or channels as well as housings, tubing etc. surrounding the chambers, which allow the circulation of hot or cold gas or liquid around at least a part of the chamber. Preferably hot air will be used to heat chamber (2).

One way of preparing an analyte comprised in an organic sample involves selective binding or preferential adsorption of the analyte to a surface, which allows in a further step the removal of the solubilzed organic sample depleted of analyte and, thus, the removal of those components of the organic sample, which are not needed. The surface capable of binding or adsorbing the analyte can be provided at the walls of the channels or chambers of the device. It is preferred that such a surface is provided near the end of the chamber opposite the means for reversibly changing the volume. The size of the surface area of the chamber, which is modified to be capable of selective binding will depend on the amount of analyte to be bound. In an even more preferred embodiment in at least one of the chambers (2, 3, 15, 20, 21) in particular in chamber (2) or (3) or in at least one of the channel(s) (6, 8, 10, 17, 24, 25) particles (18) are provided capable of binding or adsorbing the analyte. The beads can be of any material allowing binding or adsorbing the analyte or can be coated with such a material. Materials allowing binding of various analytes are well known in the art and include without limitation silica, silanized polyvinyl alcohol or glass for DNA, oligo-dT for mRNA, antibodies and/or binding peptides or fragments thereof for proteins. Further examples include specific ligands for analytes such as carbohydrates, peptides, thiols, metal ions, mimetic peptide substances, lipids, phospholipids, lectins, antigens, receptors and oligonucleotides. The skilled practitioner can without undue burden select an appropriate material for a given analyte, which he wants to purify.

In a particularly preferred embodiment in at least one of the chambers (2, 3, 15, 20, 21) or in at least one of the channel(s) (6, 8, 10, 17, 24, 25) magnetic particles (18) are provided capable of binding or adsorbing the analyte. The use of magnetic particles for the purpose of purifying analytes is well known in the art. A large variety of different magnetic particles are commercially available. They can be made of a many different materials, however, they all comprise materials, e.g. ferromagnetic, paramagnetic, superparamagnetic particles, which are attractable by a magnetic field. Thus they can be made, for example, of ferromagnetic paramagnetic, superparamagnetic beads, which are coated with a material allowing binding or adsorption of an analyte, e.g. glass, silica or silanized polyvinyl alcohol. The magnetic beads can be retained in any desired location of the device by applying a magnetic field to that location. Preferably the beads are retained in a region at the end of the chamber opposite the means for reversibly changing the volume. Which allows to retain the beads in a chamber, while it is possible at the same time to dislodge almost all liquid from the chamber. Thus, in a preferred embodiment of the device does not comprise a filter to retain particles. Similarly a filter is also not required in the embodiment of the device, in which the binding material coats or is attached to the chamber or the channels.

In a preferred embodiment the magnetic particles (18) have a diameter in the range from 50 nm to 50 μm, preferably from 200 nm to 20 μm. It is particularly preferred, that the diameter of the magnetic particles (18) is smaller than the diameter of the channels (6, 8, 10, 17, 24, 25) such that the magnetic particles (18) can be moved through the channels (6, 8, 10, 17, 24, 25). This prevents clogging of the channels while moving the sample solution back and forth through the channels. Appropriately, the ratio of the diameters of the magnetic particles (18) to the diameter of the channel(s) (6, 8, 10, 17) is smaller than 1:5, preferably smaller than 1:10, more preferably smaller than 1:50. Since in a preferred embodiment all purification, mixing etc. steps are carried out in chambers (2) and (3) while the further chambers (15, 20, 21) are only used to supply reagents required at the different steps of purification it is preferred that at least channels (6, 8, 10) adhere to above outlined size requirements in relation to the beads.

In a preferred embodiment once the organic sample has been depleted of analyte and the analyte has been bound or adsorpt to the material capable of binding or adsorption, in particular to magnetic beads, the depleted organic sample is removed from the bound analyte as completely as possible. In a next step the analyte can be washed, with a different reagent to remove, for example, any residual organic sample or solubilized organic sample. The device of the present invention comprises a second chamber (3) and can comprise further chambers (15, 20, 21). Any of these chambers, in particular a further chamber (20) comprises a wash solution (W). The wash solution can contain many of the components already outlined above with respect to the liquid (L), i.e. buffer, chelating agents, salts, stabilizing agents, detergents, alcohols and the like and mixtures thereof. Many wash solutions for the purification of analytes are know and their respective composition is determined by the analyte to be purified and the organic source used and can be appropriately chosen by someone of skill in the art. In general wash solutions are designed to reach at least one preferably all of the following aims: i) only marginally interfere with the binding between the analyte and the material, which bound or adsorbed the analyte, ii) stabilize the analyte and/or inhibit enzymes degrading the analyte and iii) dissolve organic sample components, which might have attached to the material binding or adsorbing the analyte. Preferably the device is provided with two wash solution comprising chambers wherein the wash solutions are preferably of different composition.

Once the organic sample has been bound to the material, preferably the magnetic beads, the analyte with or without an intermittent washing step or further process steps, as required, can be eluted from the material. Therefore, in a preferred embodiment the device of the present invention comprises an elution solution (E) in one of the chambers (2, 3, 15, 20, 21), preferably in a further chamber (21). The choice of the elution solution will primarily depend on the analyte, the material used for binding or adsorption and on further process steps performed with the analyte inside or outside the device, which might have certain buffer, salt or detergent requirements. In general an elution solution will maintain the integrity of the analyte while interfering with the binding of the analyte to the material to which it is bound.

For the elution of DNA, which was bound, e.g. to glass beads, polyvinylalcohol beads or silica coated beads, in particular to magnetic beads, low salt solutions can be used, e.g. ddH₂O, 50 mM Tris-HCl, pH 8.0 or TE (10 mM Tris-HCl, 1 mM EDTA, pH 8.0) and for the elution of proteins captured on antibodies solutions comprising high concentrations of competing binding peptides can be used for elution. A large variety of elution solutions are known for any given analyte and purification protocol can be appropriately chosen by someone of skill in the art.

During operation of the device various solutions will be passed into the chambers (2, 3) in which the purification takes place and will be discarded afterwards. Therefore, in one embodiment the device is provided with a further chamber (15) that is capable of holding all waste fluids. This chamber can be provided with a means of flow regulation or without such a means as outlined above. In another embodiment a chamber without a means for reversibly changing it volume is provided, i.e. without a plunger, in particular a gas filled compartment is provided. This chamber also has a means of flow regulation, which allows to separate the Waste chamber from the rest of the system. Only when waste is moved to the waste compartment the valve opens and allows the discharge of liquid into the waste compartment. To avoid the building up of pressure within the waste chamber during operation the waste chamber is preferably provided with a liquid tight venting means, i.e. a means which allows the air contained in the chamber to escape the chamber while retaining any waste liquid, which has been discharged into waste compartment. Examples of such means include PVF membranes like, for example, Gore-Tex® available from Gore or similar membranes and materials which swell upon contact with liquid like, e.g. gels. One example of such a gel is Porex® available from Porex Corp. USA. The provision of a liquid tight venting means assures that no hazardous material is released from the device.

In a preferred embodiment both connectors (7, 9) are provided with a means of flow regulation as outlined above, preferably a valve or a septum. It is also preferred that the chambers (2, 3, 15, 20, 21) and channels are fluid tight against the surrounding when the connector(s) (7, 9) are closed to assure contamination free handling of the sample.

In a preferred embodiment the device of the present invention comprises magnetic beads as outlined above. In this embodiment it is also preferred that the device is designed to accommodate the positioning of a magnet in the vicinity of the device, preferably at the end of the chamber(s), preferably the first (2) or the second chamber (3). Such an accommodation can be, for example, an indention, crevice and/or a thinning of the material, which allows bringing a magnet into close proximity to the channels and/or to the chambers and also allows the generation of a strong magnetic field within the chamber(s) or channel(s). Thus a magnetic field is created in only a part of the device, which in turn allows to concentrate the magnetic beads in a small volume and to remove almost all residual liquid from the beads.

It is also envisioned that a magnetic device is incorporated into the device of the present invention, which allows the generation of magnetic fields in selected regions of the device at a selected time point. Such a magnetic device can be, for example, a permanent magnet, e.g. rare earth magnet, which is capable of being moved into the vicinity of the chamber and/or channels and of being removed from the chamber. Alternatively the magnet can be an electromagnet, which preferably is stationary, however, is switched on or of as desired. The shape of the magnet is not particularly limited. It can create, for example, a spot like or an angular magnetic field.

In a preferred embodiment the device of the present invention comprises a base plate (30) comprising the fluidic connections, i.e. channels, between at least chambers (2) and (3), preferably between chambers (2) and (3) and further chambers (15, 20, 21). Preferably the base plate (30) comprises channels (6, 8, 10, 17, 24, 25) and the connector(s) (7, 9). The chambers themselves are not part of the base plate (even so one or more might be permanently attached or connected to the base plate) but contact the base plate at the one end of the chamber, which makes connection with the channels (6, 8, 17, 24, 25). In a preferred embodiment the axes of the chambers are arranged perpendicular to the plane of the base plate and protrude from the base plate. In other embodiments it is possible that the axes of the chambers are arranged with an angle towards the plane of the base plate. Preferably this angle is between about 45° to 90°. Different chambers can be arranged with different angles, however, it is preferred that all chambers have the same angle, i.e. that their axes are parallel to each other.

To allow easy access and manipulation of all means for controlling the volume in the chambers it is preferred that all chambers are located on one side of the plane of the base plate. The upper and lower side of the base plate does not have to be plain but can be structured to include indentions, cut outs, ledges, holding receptacles, channels, valves, and/or can be moulded to form a waste container. The dimensions of the plate can be chosen as required by the number of functionalities included, and thus, the number of chambers required too provide reagent storage capacity and reaction chambers. Preferably the size of the base plate is between about 4 cm² and about 1000 cm², more preferably between about 10 Cm² and about 200 cm² and more preferably around 50 cm². To allow cheap manufacturing of the base plate it is preferred that the majority of the channels are located on one side and are covered by a sealing plate or film which make some fluid tight towards the environment. In this embodiment the channels on one site of the base plate can be connected through holes penetrating the base plate and which are connected on the other side with the chambers protruding from the base plate. It is possible to provide valves at any desired point in the flow path, for example, by covering part of the channel with a flexible membrane that can be pushed into the channel to block the flow through the channel. Preferably the flexible membranes are arranged on the same side of the base plate on which the chambers are attached, which allows the actuation of the valves, i.e. pushing in of the membrane, to be effected from the same side from which also the actuation of the means for reversibly changing the volume is effected.

The device of the present invention allows preparation of a sample and the isolation of an analyte from the sample in a closed system without contamination of the environment or the analyte. However, it will often be desired not only to prepare an analyte but also to determine it quantitatively and/or qualitatively. In fact in many applications it will be desirable to quantitatively and/or qualitatively detect several analytes simultaneously. This can be interesting, for example, if several different pathogens, e.g. bacteria and/or virus need to be detected in a patient sample.

Thus, in a preferred embodiment, besides the functionality of preparation of analytes further functionalities can be part of the device of the present invention. These functionalities include without limitation nucleic acid amplification, analyte separation, analyte detection, enzymatic or chemical modification of analyte(s), in particular, nucleic acid sequencing, nucleic acid synthesis, nucleic acid cloning, desalting, buffer changing, analyte labelling, reverse transcription of RNA analytes, refolding of protein analytes, chromatography, e.g. size separation, ion exchange or affinity chromatography and/or protein expression.

These one, two or more functionalities are fluidically connected to the device of the present invention, which allows transfer of the analyte from one functionality to the next. Preferably all further functionalities are separated from each other by means of controlling the flow. The analyte is moved between different functionalities by appropriately moving the means for reversibly changing the volume. If, for example, DNA has been eluted from beads in chamber (2) than the eluted DNA will be dislodged through connector (9) by moving the plunger (4) all the way to the bottom of the chamber without dislodging the beads and then the sample is further moved through the system by pushing the piston of chamber (21) in whereby elution solution is used to flush the sample, which has been discharged through the connector (9) through the system until it reaches the next functionality, for example a PCR chamber (40) or a mixing chamber or channel. Then the valves in connector (9) will be closed and essentially the whole analyte has been moved into the next functionality, for example the PCR functionality, where it can now be mixed with reagents required for PCR-amplification including, for example, polymerases, nucleotides, buffers, salts and primers. Consistently in the embodiment in which a nucleic acid amplification functionality is further provided in the device of the present invention the device preferably comprises additional chambers which can hold premixes of, e.g. enzymes, enzyme buffers, primers and/or nucleotides as required by the particular amplification method employed. If the analyte is, for example, DNA, the amplification method employed will preferably be PCR, which requires a cyclic temperature change, e.g. denaturation, annealing and extension. However several isothermic methods for DNA amplification are also known in the art which will result in the amplification of the target DNA. If the analyte is RNA the amplification will usually be preceded by a reverse transcription of the RNA into a cDNA.

The analyte detection functionality preferably comprises an area in which molecules that are capable of specific binding to the analyte are immobilized, the incubation of the analyte with this molecules under conditions which allow specific interaction followed by a washing step to remove molecules that have boundnon-specifically to the analyte binding molecules and subsequently the detection of the amount and type of analyte bound. In a preferred embodiment more than one analyte, more than 100 different even more preferably more than 1,000 different analytes are bound on (a) surface(s) in a channel or chamber of the device of the present invention, in a particular preferred embodiment the surface can be a so called DNA or protein chip, which are well known in the art and which all can be employed without limitation in the device of the present invention. The appropriate chip to chose will also be determined by the method of detection which is used to determine whether an analyte has bound to the surface or not. Well known methods which all can equally be employed include without limitation photometric, potentiometric and other electrochemical methods. Photometric methods require in most cases the attachment or introduction of markers into the analyte, which can be exited by or which adsorb electromagnetic waves of particular wave lengths.

A particular preferred device of the present invention includes an analyte preparation functionality, which is fluidically connected to an amplification functionality, which in turn is fluidically connected to a detection functionality.

This preferred device allows the integrated and contamination free preparation, amplification and detection of an analyte that is applied to the device in a sample.

As pointed out above in a preferred embodiment of the device of the present invention further functionalities are included in the device and it is particularly preferred that those functionalities are also comprised on the same base plate (30). Consequently, the base plate can further comprise connections to additional reagents storage (29) and or mixing chambers, meandering channels for mixing solutions, valves (32), chambers or channels comprising immobilized analyte binding molecules preferably DNA or protein chips (42) or regions which thermically decouple parts of the base plate from the rest of the base plate. Such thermic decoupling can be provided, for example, by a cut out section (35) for PCR amplification.

It is further preferred that the device of the present invention is provided with an enclosure (1). The enclosure (1) is preferably made of synthetic material, e.g. polypropylene, polyethylene, polystyrene, polycarbonate or the like. Preferably the enclosure will enclose all chambers of the device. The enclosure can be attached to the base plate. It can be locked, for example, with ledges that slide into respective holes on the base plate. Of course it is also possible to glue or otherwise attach the enclosure. In the embodiment of the device, which uses connectible chambers the enclosure can provide receptacles corresponding to the connectible chambers, to stabilize the chambers once they have been connected to the channels. Again to prevent a mix up of the chambers the receptacles can be color or shape coded.

If the device of the present invention is enclosed in an enclosure (1) it is preferred that at least the first chamber, preferably all chambers (2, 3, 15, 20, 21) open up towards the edge of the enclosure (1), so that the means for reversibly changing the volume (4, 5, 14, 22, 23) can be operated from the outside. It is further preferred that the enclosure (1) is provided with a means (13) for attaching and/or positioning the device in a corresponding receptacle of an apparatus, which is equipped to allow motorized, preferably automatic changing of the volume of at least one chamber and/or an automated engagement of a magnet, with which magnetic particles can be kept in particular positions in the channels or chambers. It is preferred that this means can be easily released and that no special tools are necessary to do so.

A further aspect of the invention is a kit of parts comprising a base plate comprising at least a channel (6, 8, 10), wherein a connector (7, 9), which is provided with a means of flow regulation, is connected to the channel (6, 8, 10) for loading of a sample solution, and at least one chamber (3) preferably two, three, four, five, six, seven, eight, nine, ten or more further chambers, which comprise reagents. The reagents can be any of the reagents indicated above and as required by the respective purification, amplification and/or detection protocol. Thus, preferably the reagents are selected from the group of lysis solutions (with or without particles coated with binding materials), binding solutions, washing solutions, elution solutions, buffer solutions, enzyme solutions, nucleotide solutions, and hybridization solutions.

Preferably the base plate comprises one permanently attached chamber (2) which is preferably empty while the additionally provided chambers comprising reagents are supplied separated from the base plate. It is further preferred that the chambers and/or the base plate is sealed, i.e. that all openings are either closed by a seal as outlined above and/or by a plunger, i.e. detachable chambers are typically sealed towards the environment by a plunger on one side and a seal on the other side.

The device of the present invention can be equipped with a means of information storage, i.e. a bar code, a chip etc. which allows the automated device actuating the means for reversibly changing the volume to determine what type of device has been or will be placed into the automated device and allow it to choose a series of manipulations accordingly. The purification and detection scheme could, however, also be stored on a chip in the device of the present invention, which will be read by the automated device once the device of the present invention has been inserted. This decreases the risk of inappropriately using the device of the present invention, i.e. perform a sequence of purification steps for which the device is not intended.

A further aspect of the present invention is a method for contamination free preparation of analyte(s) from organic substance comprised in a sample solution (P), using the device of the present invention comprising the following steps:

introducing a predetermined volume of sample solution (P) through a connector (7, 9) into the first (2) or second chamber (3),

interrupting the flow directed through the connector (7, 9),

moving back and forth of the sample solution (P) between the first (2) and the second (3) chamber in such that the sample solution is contacted with material binding or adsorbing the analyte and that the analyte(s) comprised in the sample solution (P) can bind or adsorb to the material, and

dislodging of the analyte(s) through a connector (7, 9).

The method provides a reliable automated preparation of analyte comprising sample liquids. After interrupting the flow through the first connector the sample solution is moved through the channel connecting both chambers. This is effected by reducing the volume of the first chamber and at the same time passively or actively enlarging the volume of the second chamber. The flow of the liquids back into the first chamber is effected by reducing the volume of the second chamber and passively enlarging the volume of the first chamber or actively enlarging the volume of the first chamber and passively and/or actively reducing the volume of the second chamber. A contamination of the sample or the environment as well as a gas inclusion is excluded. The chambers and the channels form a closed system.

The method of the present invention can be used to isolate a variety of analytes comprised in organic samples including but not limited to nucleic acids, e.g. DNA and RNA, polypeptides, non-peptide signaling molecules and the like. Preferably the analyte is selected from the group consisting of nucleic acids, in particular DNA or RNA and polypeptides.

The proposed method may comprise the following further step: optionally eluting the analyte from said material.

The material binding or adsorbing the analyte has been described above and can coat at least part of the surface of the chambers and/or channels or particles, in particular magnetic particles comprised within the chambers and/or channels. If the analyte is bound to the surface of the channels or chambers the analyte has to be eluted from the surface of the chamber or channels or the particles prior to being dislodged through a connector. If the analyte is bound to magnetic particles the analyte(s) is (are) either dislodged bound to the magnetic particles (18) or separate from the magnetic particles (18) after an elution step. In the first case the magnet will be moved away from the device or will be switched of in order to release the beads and in the later case the beads will be retained in the device by magnetic forces, while the eluted analyte is dislodged.

In one embodiment of the method of the present invention the sample solution (P) is moved back and forth by alternately extending and reducing the volume of the first chamber (2). In a preferred embodiment the sample solution (P) is moved back and forth by alternately moving the first (4) and the second means for reversibly changing the volume (5) towards the end of the chamber opposite to the means (4, 5). This mode of directing the fluid flow is preferred because it does not require to pull out one of the means for reversibly changing the volume, i.e. it does not require a connection capable of being pulled between such a means and, for example, an externally positioned motorized apparatus.

In a preferred method of the invention the organic sample is in a further step sonicated and/or mixed with a liquid (L) for solubilization of the organic substance comprised in the sample solution in order to more efficiently release any analyte comprised in the organic sample.

In particular when cell containing samples are processed genomic DNA will be released by most solubilization techniques, which can hamper further preparation steps. It is desirable that this genomic DNA is broken up, which can be effected, for example, by sonification and/or by shearing. Sufficient shearing forces can be exerted by vigorous mixing of the sample solution with the liquid, i.e. by rigorously passing the liquid back and forth between two chambers. In addition the sample can be heated within the device for solubilization. While not required for most solubilization tasks heating might be advantageous for samples, e.g. virus, which are hard to solubilize.

Depending on the type of coating used for the binding material the solubilized analyte might not bind to the binding material under the conditions, e.g. pH, salt, alcohol content, which results when the sample is mixed with the lysis buffer. In these cases it might be required to add an additional solution, which is called binding solution (B), which allows the analyte to bind to the binding material. Such binding solution can contain, for example, alcohol at various concentrations, in particular ethanol or isopropyl alcohol.

In a preferred embodiment of the method employing magnetic particles, the magnetic particles (18) and the analyte bound thereon are retained in a predetermined region of a chamber, preferably at the end of the first (2) or second chamber (3) opposite to the means for reversibly changing the volume (4, 5) by generating a magnetic field in the predetermined region of the chamber (2, 3). As outlined above this can be achieved, for example, by moving a magnet into the vicinity of a chamber or channel or by switching on an electromagnet located within the device.

It is preferred that after the organic substance has been brought into contact with the analyte binding material that in a further step sample solution (P) depleted of analyte(s) is substantially removed from the chamber(s) (2, 3). This can be achieved, for example, by retaining magnetic particles in the vicinity of the channel at the end of the chamber, which allows the means for reversibly changing the volume to move almost to the end of the chamber without dislodging the magnetic beads into the channel and/or into another chamber. A similar effect can be achieved if the surface at the end of the chamber is coated with a material capable of binding or adsorbing an analyte. It is desirable to almost completely remove sample solution (P) depleted of analyte to decrease the residual amount of contaminating components from the sample solution, which have to be removed in one or more subsequent washing steps.

In most embodiments of the method of the present invention a wash solution (W) as outlined above will be used to decrease the amount of residual contaminating components of the sample solution adhering to the analyte and/or the binding material. Thus, in one embodiment wash solution (W) provided in one further chamber (20) is flown over the binding material coating the surface of the chambers or channels or mixed with the particles, in particular mixed with the magnetic particles (18), preferably by alternately moving the first or the second means for reversibly changing the volume (4, 5) and the third means for reversibly changing the volume (22) towards the end of the chamber opposite to the means (4, 5, 22). However, it is also envisioned that the analyte is dislodged from the device without an intermittent wash step.

In those embodiments of the method of the present invention employing magnetic beads in a further step the magnetic particles (18) and the analyte bound thereon are retained in a predetermined region of a chamber, preferably at the end of the first (2) or second chamber (3) opposite to the means for reversibly changing the volume (4, 5) by generating a magnetic field in a predetermined region of the chamber (2, 3). In most cases one washing step will suffice it is, however, possible to repeat the washing step using the same or (a) different wash solution(s) any number of time as required. In a preferred embodiment two washing steps with two different washing solutions are carried out.

At the end of the washing step(s) it is preferred that all wash solution (W) is substantially removed from the chamber(s) (2, 3). This is of particular importance, if any residual washing solution would interfere with subsequent processes like, for example, the PCR amplification of the analyte.

In the embodiments of the invention, in which the analyte is dislodged from the device unbound to any binding material an elution step is required and, therefore, an elution solution (E) provided in one further chamber (21) is flown over the surface coated with binding material or mixed with the particles, preferably magnetic particles (18), preferably by alternately moving the first or the second means for reversibly changing the volume (4, 5) and a further means for reversibly changing the volume (22) towards the end of the chamber opposite to the means (4, 5, 22). Depending on the analyte and the binding material efficient elution might require two or more elutions, long incubation times of about 30 min or more or an increase of the temperature. A complete removal of analyte is, however, often not required, since already small amounts of analyte can be sufficient for later detection, e.g. if the analyte is DNA and the DNA is later PCR amplified.

In those embodiments of the method of the present invention employing magnetic beads in a further step the magnetic particles (18) are retained in a predetermined region of a chamber, preferably the end of the first (2) or second chamber (3) opposite to the means for reversibly changing the volume (4, 5) by generating a magnetic field in a predetermined region of the chamber.

After elution of the analyte from the binding material in a further step elution solution (E) comprising the analyte is substantially dislodged from the chamber (2, 3) by moving the means for reversibly changing the volume almost all the way to the end of the chamber, however, without dislodging any beads. This will allow a maximum yield of analyte, since only a very small volume of analyte comprising elution solution will remain in the device. In addition the elution of the analyte can be effected in a volume much smaller than the volume of the sample solution originally applied. This will lead to an enrichment, i.e. an increase in concentration of the analyte compared to the starting material. Such concentration can be desirable, e.g. when the analyte is contained in the sample solution only in very small amounts, which might otherwise be below the detection limit.

The device of the present invention allows the handling of very small sample and fluid volumes and in a preferred embodiment of the invention the elution volume is in a range from about 1 to about 100 μl.

Further method steps of the method of the present invention can comprise the amplification, e.g. PCR or RT-PCR amplification, and/or detection, e.g. by hybridization or binding, of the dislodged analyte. It is possible to automatically apply the elution solution to a device for automated amplification and/or detection of analytes, which can be integrated with the device of the present invention. This method avoids any manual handling of the analyte after it has been injected into the device.

As pointed out above the device of the present invention can comprise one or more chambers which are used for the disposal of waste liquids. The advantage of this approach is that all potentially contaminating waste is maintained in the fluidically tight device. Therefore, the method comprises in some embodiment the further step that the sample solution (P) depleted of analyte, the liquid (L) for solubilization mixed with the sample solution (P) depleted of analyte, the wash solution (W) the magnetic particles (18) and/or any other waste solution produced during the purification process is (are) collected in one of the chambers (15) and are discarded after dislodging or detection of the analyte together with the device, preferably together with the base plate (30) and/or enclosure (1).

The device of the present invention provides a variety of ways to direct the fluid flow between the different chambers. In one embodiment of the method of the present invention the flow of liquids between two chambers is controlled by alternately extending and reducing the volume of one chamber, while keeping the volume of all but one of the other chambers constant. However, it is also envisioned that the flow between three or more chambers is controlled. If, for example, two reagents are needed for one process step, which are stored separately and are to be added to the sample solution at the same time it is possible to simultaneously introduce both reagents into, for example, the first chamber (2) or second chamber (3) by pushing in the pistons of both chambers.

In a preferred embodiment of the method of the present invention the flow of liquids between two or three, preferably two chambers is controlled exclusively by alternately moving one means and a second means for reversibly changing the volume towards the end of the chamber opposite to the means, while keeping the volume of all other chambers constant. It is of course possible albeit less preferred to combine different ways of controlling the flow of fluids in any desired order.

To prevent contamination during performance of the method it is preferred that after the sample solution (P) has been introduced into the device no further liquid is introduced into the system formed by the chambers (2, 3, 15, 20, 21) and the channels (6, 8, 10, 17, 24, 25). This requires that all reagents and solutions necessary for preparation of the analyte are already located in the respective chambers of the device prior to the introduction of the sample solution. This can be achieved, for example, by connecting all connectable chambers filled with the different reagents prior to loading of the sample, by using a prefilled device or by sequentially loading the different chambers of the fully assembled device prior to loading of the sample solution (P) by sequential injection of the various reagents through a connector (7, 9) and releasing the means for reversibly changing the volume of only the one chamber to be loaded. Once all chambers are in place (with or without and injected a sample) it is usually a first step to flush the whole system with liquid in order to purge essentially all air from the system in order to prevent clogging by air trapped air bubbles and to reduce the compressible volume. A reduced compressible volume within the closed system is also desirable because the amounts of fluids that are moved through the system by the actuation of the plungers can be more accurately determined.

The following examples are included to demonstrate preferred embodiments of the invention. It should be appreciated by those of skill in the art that the techniques disclosed in the examples that follow represent techniques discovered by the inventors to function well in the practice of the invention, and thus can be considered preferred modes for its practice. However, those of skill in the art should, in light of the present disclosure, appreciate that many changes can be made in the specific embodiments that are disclosed without departing from the spirit and scope of the invention as set out in the appended claims. All references cited are incorporated herein by reference.

### BRIEF DESCRIPTION OF THE FIGURES AND DRAWINGS

FIG. 1: Shows two top views of a first device, wherein no pistons and plungers have been inserted into the device depicted on the left side and an assembled device, i.e. with engaged pistons and plungers, is depicted on the right side.

FIG. 2: Shows a side view of a second device with two reagent chambers, a waste chamber and to reaction chambers.

FIG. 3: Shows a method according to the invention on the basis of a side view of a third device.

FIG. 4: Shows a side view of a fourth device with a base plate including a PCR and a detection unit with one detachable and one fixed chamber.

FIG. 5: Shows a side view of the fourth device with three detachable chambers attached, a syringe with sample attached and part of the sample introduced into mixing chamber (2).

FIG. 6: Shows a top view of the fourth device.

### EXAMPLES

### Example 1

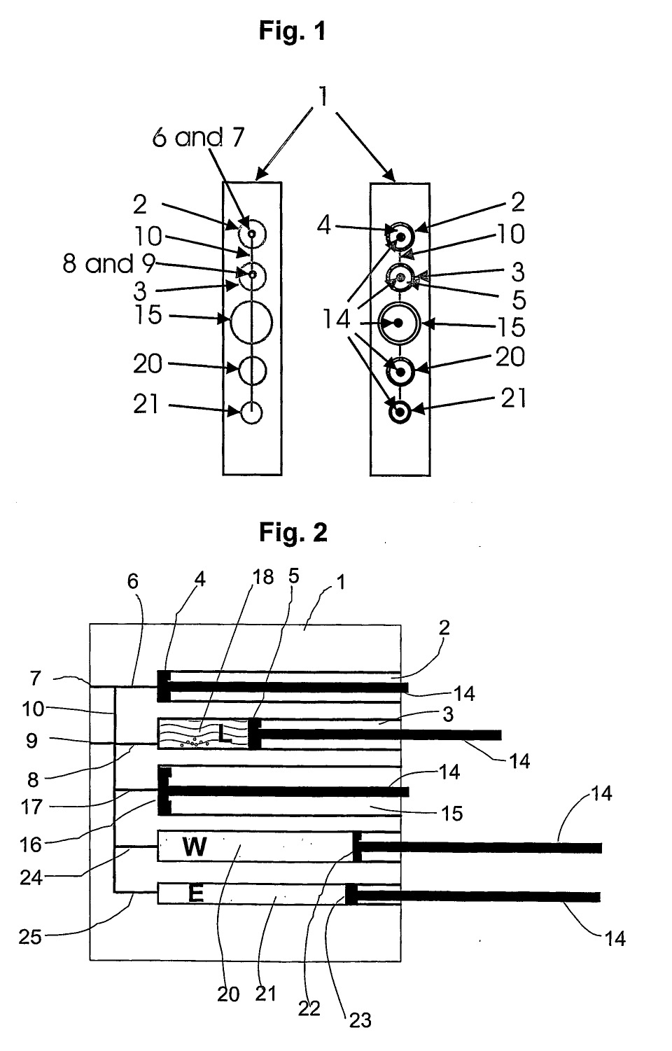

In an enclosure (1) of a device as shown in FIG. 1, which is made of a transparent synthetic material, a first cylinder (2) and a second cylinder (3) are provided. In the first cylinder (2) a first piston (4) and in the second cylinder (3) a second piston (5) is relocatably included. The pistons (3, 4) can be provided with piston rods. It is also possible, that the pistons are only cylindrical formed and that the piston rods are omitted. The pistons (4, 5) can be made of e.g. rubber or synthetic material. They thereby seal the chambers from the surrounding and prevent the entering of contaminants. The first (4) and the second piston (5) together form with the first (2) and second cylinder (3) a first and a second chamber, which exhibit a changeable volume. From one end of the first cylinder (2) opposite the first piston (4) a first channel (6) extends, which is connected to a first connector (7), which is provided at the edge of the enclosure (1). From one end of the second cylinder (3) opposite-thq second piston (5) a second channel (8) extends, which is connected to a second connector (9), which is provided at the edge of the enclosure (1). The second channel (8) is connected with the first cylinder (2) through a connecting channel (10) and with the first channel (6) through the first cylinder (2). In the connection between first (2) and second chamber (3) no valve is provided. A third connector (11) can be connected through a third channel (12) with the first cylinder (2). The cylinders (2, 3) can be, e.g. tapered off at the ends, where the channels (6, 8) extend from. The piston can also be tapered off, so that the residual volume is very small. In case cylindrical pistons (4, 5) are used, a residual volume remains in the cylinders (2, 3) when the piston is completely pushed in. If magnetic particles are used to bind the analyte the magnetic particles can be held back by the magnetic field in the small residual volume and can be concentrated accordingly.

The device, furthermore, can be provided with four breakthroughs or clips (13) for fitting and/or positioning in a receptacle of an apparatus (not shown here) for automated operation of the pistons (4, 5).

### Example 2

In FIG. 2 another device according to the invention is depicted. In contrast to the device shown in FIG. 1, the connection channel (10) connects the first (6) to the second channel (8). The cylinders (2, 3) are not tapered off in the area of the channels (6, 8). Furthermore, connecting rods (14) are depicted in FIG. 2, which are part of an equipment for automated operation of the pistons (4, 5) that is not further explained here. The connecting rods can be attached to the pistons or only make loose contact. The device depicted in FIG. 2 provides besides the first (2) and second cylinder (3) three further cylinders (15, 20, 21), which are each provided with further pistons (16, 22, 23). Each of the further cylinders (15, 20, 21) provides a further channel (17, 24, 25) that extends from the end of the further cylinder (15, 20, 21) opposite the further piston (16, 22, 23) and that is connected with the connecting channel (10).

In the second chamber a lysis solution (L) and magnetic beads or magnetic particles (18), respectively, are provided. One of the further chambers formed by one of the further cylinders (15, 20, 21) and pistons (16, 22, 23) contains wash solution (W), another further chamber an elution solution (E). The chamber arranged in the middle of the device is a waste chamber and holds solutions to be discarded. The sample solution comprising analyte (not shown) can be injected through connector (7) or (9) into chamber (2) or (3).

### Example 3

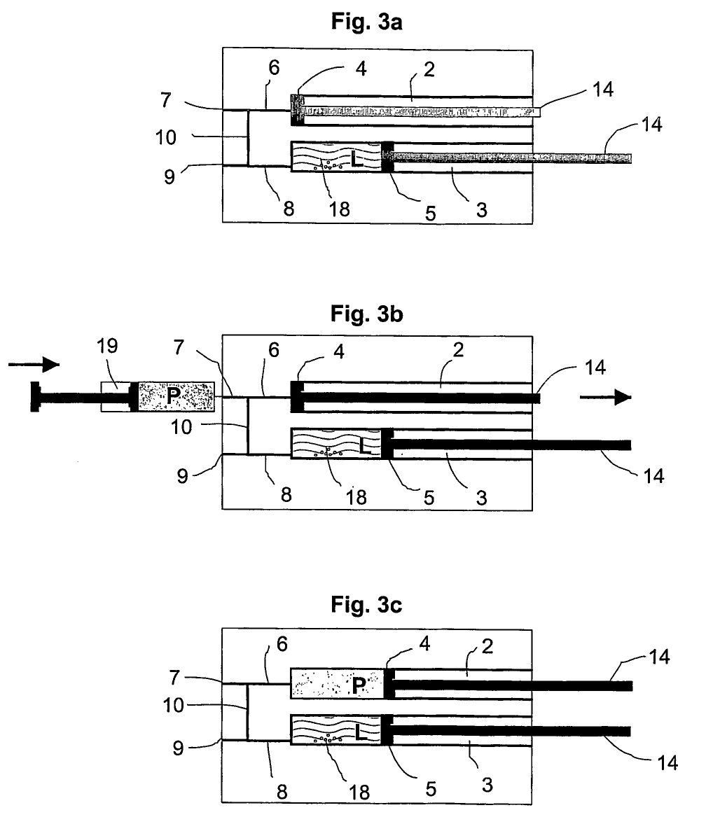

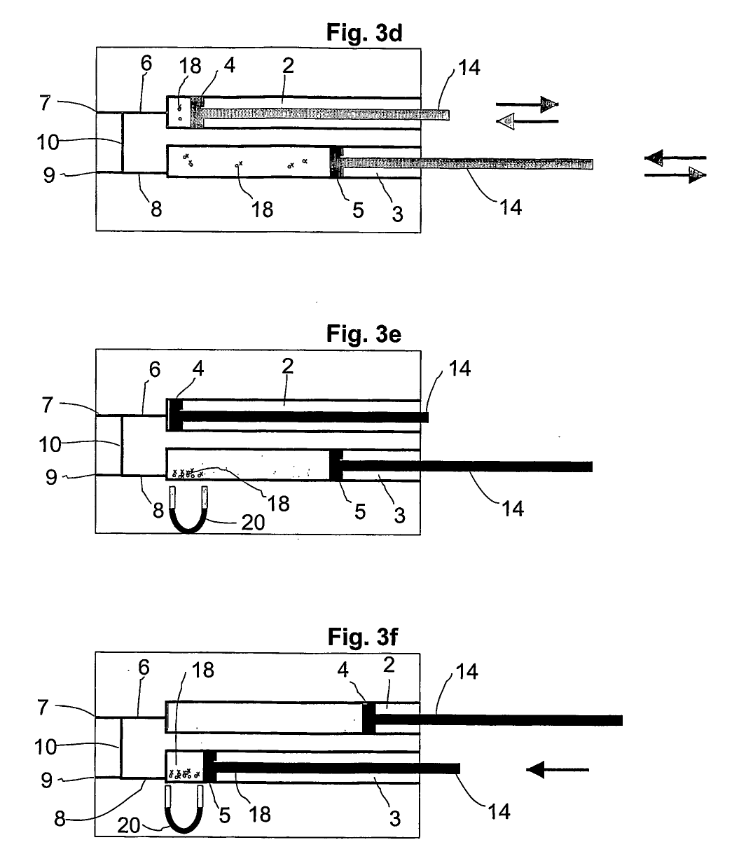

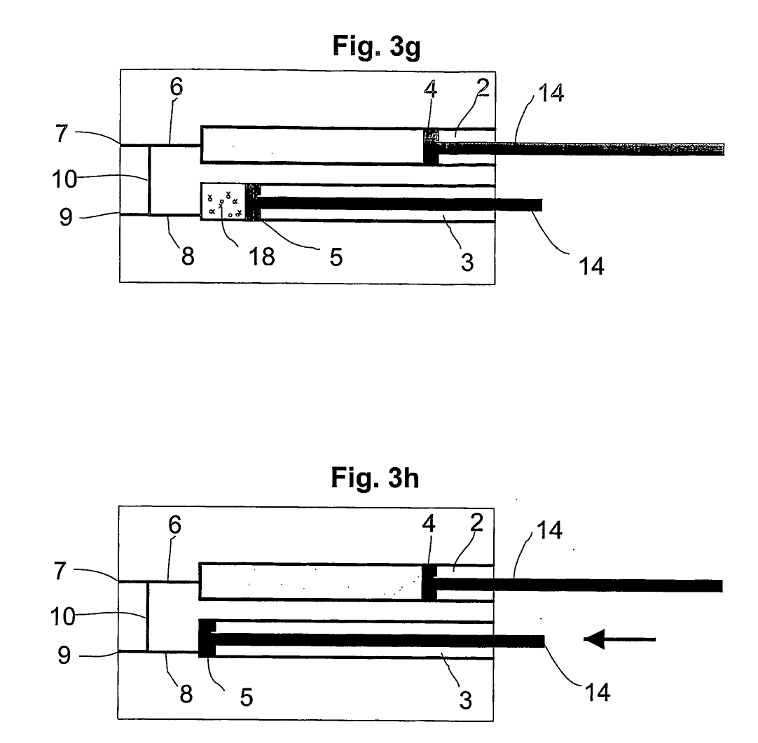

A preferred mode of carrying out the method of the invention is shown on the basis of the device depicted in FIGS. 3a to 3h. The third device has a design similar to the device shown in FIG. 2. Only the further chambers (15, 20, 21) are not depicted here.

In FIG. 3a the first piston (4) is completely moved into the first cylinder (2). The first chamber has practically no residual volume in this state. In the second cylinder (5) the second piston (5) is inserted approximately half way. In chamber (2) the lysis solution (L) and the magnetic particles (18) are provided. The magnetic particles are coated in such that the analytes to be detected can bind thereon. For DNA purification the surface of the magnetic particles (18) can comprise substances such as silica polyvinyl alcohol or glass, which bind nucleic acids. Of course it is also possible to bind specific ligands to the surface of the magnetic particles, such as antibodies, carbohydrates, peptides, thiols, metal ions, peptide mimetic substances, lipids, phospholipids, lectins, antigens, receptors or oligonucleotides. The total volume of the magnetic particles (18) is small compared to the maximal volumes of the first and the second chamber. As pointed out above the device depicted in FIG. 3a could also be delivered to a customer without the connecting rods (14), if necessary. The device can be placed as a single use cassette in an appropriate apparatus for automated operation of the pistons (4, 5).

In the following the steps of a preferred embodiment of the method are further explained:

In FIG. 3b a synthetic coating, seal or septum (not shown here) closing the first connector (7) is punched with the injection needle of an injection syringe (19). The injection syringe (19) contains the sample solution (P). The second piston (5) is held in position with one of the connecting rods (14). At the same time, the sample solution (P) is pressed into the first channel (6) with the injection syringe (19). The first piston (4) is not held in its position by a connecting rod, it is moveable. Therefore, the sample solution (P) flows into the first chamber (2) (as shown in FIG. 3c). Afterwards, the first connector (7) is closed. This can occur by a valve not shown here, e.g. a valve that allows a flow only in one direction or by withdrawal of the syringe.

The lysis solution (L) and the sample solution (P) are then moved back and forth through the connecting channel (10) between the first (2) and second chamber (3) by alternately moving of the first (4) and the second piston (5) in the direction of the first (6) and second channel (8) (see FIG. 3d). The movement of the pistons (4, 5) is carried out by alternately pushing in the connecting rods (14). The connecting rod (14), which is not pushed in does not apply resistance against the movement of the respective other piston (4, 5). That is, by pressing the first (4) or second piston (5) into the direction of the first (6) or second channel (8), respectively, the other piston is being moved backwards by the liquid that is pressed into the other chamber. By moving the liquid back and forth the lysis solution (L) is mixed intensively with the sample solution (P). The sample solution (P) undergoes an extreme acceleration while pressed through the channels (6, 8, 10) which preferably have a diameter in the range of 400 to 600 μm. The thereby generated shearing forces support the dissolving of aggregates of th organic substance, which might have been formed in the sample. The sample solution (P) now contains e.g. cell fragments and DNA. The DNA binds to the magnetic particles (18) that can move freely in the sample solution (P).

As a next step after extensive washing a magnetic field is applied by a magnet (20), for instance above a segment in the second chamber (3) near the opening of the second channel (8). Hence, the magnetic particles (18) with the analytes bound thereon are held in this segment (see FIG. 3e). The volume of the sample solution in the second chamber is reduced by moving the second piston (5) down into the chamber until it reaches the segment where the magnetic particles (18) are fixed (see FIG. 3f). Accordingly the volume is reduced by many times compared to the starting volume of the sample solution. The residual volume, which comprises the beads can be very small, e.g. is between 1 to 100 μl.

Then the magnetic field is removed (see FIG. 3g). This can be done by e.g. removing the magnet or turning off an electromagnet as appropriate. Now the second connector (9) can be opened. Afterwards (as shown in FIG. 3h) the residual sample volume containing the magnetic particles (18) with the biopolymers bound thereon can be dislodged through the second connector (9) by further pressing down the second piston (5).

### Example 4

When combining the teaching of FIGS. 2 and 3 another variation of the method described above is possible. The method can be conducted in such that the sample solution to be discarded (as shown in FIG. 3h), that was pressed into the first chamber (2), is transferred into a special further chamber (15) designed for the intake of such liquid, i.e. a waste chamber. In FIG. 2 such a chamber is depicted as the middle chamber. After dissolving the organic substance and binding of the analyte a wash buffer can be introduced into the device and mixed with the sample solution (P), which contains the magnetic particles (18), by moving the appropriate pistons back and forth as depicted in FIG. 3. In analogy to the method described in Example 3 (and FIG. 3) the magnetic particles (18) can be concentrated in a small residual volume and can subsequently be mixed with an elution solution (E) by moving the appropriate pistons back and forth. The elution solution (E) can be, for example, pure or buffered water containing low salt, if DNA is to be eluted from glass or silica beads. Depending on the coating of the magnetic particles (18) pH-active substances, chaotropic substances, chelating agents, phosphate, ligands, ligand analoga or peptides can be added to the solution, wherein these additiva release the analytes. It is also possible to support elution by increasing the temperature during elution. By treating the magnetic particles with the elution solution (E) the analytes, preferably DNA are eluted from the particles. The magnetic particles (18) can be held back e.g. in the second chamber (3) by applying a magnetic field, while the elution solution (E) containing the biopolymers is dislodged through the second connector (9). It is possible to elute the analyte in a small elution volume, if compared to the volume of the sample solution, e.g. to reduce the volume of the elution solution (E) to 5 to 100 μl.

### Example 5

In the following a protocol of a preferred method using the device shown in FIG. 1 is described in further detail. Initially deionized water is loaded with an injection syringe through the second connector (9) to remove air from the channels (6, 8, 10) and the chamber (2, 3). To completely remove air from the device it is affixed in an appropriate receptacle of an automated analysis apparatus. With such an apparatus the pistons (4, 5) are moved according to a predetermined computerized program and designated valves are opened and closed, if needed.

Next, the water contained in the chamber (2, 3) is pressed out through the first connector (7) by moving the pistons (4, 5). Afterwards, the first chamber is filled through the second connector (9) with a mixture, which contains 125 μl lysis buffer, 360 μl binding buffer and 14 μl of a suspension of magnetic beads (18) or already provided in a further chamber not depicted here. The buffer and the magnetic beads can be, for example from the “chemagic DNA Blood 100 Kit” (catalog number 01-01-1001 Chemagen). Then 100 μl blood, inhibited to coagulate by, e.g. EDTA (ethylenediaminetetraacetate), is loaded into the first chamber (2) through the first connector (7). The second connector (9) is closed. Then the solution containing the sample and the mixture is pumped back and forth about ten times between the first (2) and the second chamber (3) by alternately pressing the first (4) and the second piston (5) into the chamber. Then the beads are incubated for 5 min at room temperature in the first chamber (2). Subsequently a magnetic field is applied near the end of the chamber in such a way that the magnetic beads (18) are held in this area. The liquid contained in the first chamber (2) is removed almost entirely through the first connector (7) without dislodging the magnetic beads. The cone like recess in the first chamber (2) near the first channel (6) is designed in such that the volume of the magnetic beads can fit in.

Then 300 μl of a wash buffer P3 of the kit mentioned above are loaded into the first chamber (2) through the second connector (9) or from a further chamber (15) not depicted here. By alternately moving the first (4) and the second piston (5) the wash buffer P3 together with the magnetic beads (18) is pumped back and forth about 10 times between the first (2) and the second chamber (3). A magnetic field is not applied during the mixing. An intensive admixing of the magnetic beads (18) and the wash buffer P3 is provided.

Then again a magnetic filed is applied in the area of the cone like recess of the first chamber (2), such that the magnetic beads (18) are held there. The wash buffer P3 is almost entirely dislodged through the first connector (7). The described wash step can be repeated any number of the times as required. Afterwards the beads are washed with a further wash buffer P4 of the kit mentioned above.

Then 600 μl of a wash buffer P5 of the kit mentioned above are slowly loaded through the second connector (9) into the first chamber (3) while a magnetic field is applied. Alternatively the wash buffer P5 is loaded from a further chamber (20) of the device not depicted here. Loading has to be carried out in such that an aggregate formed by the magnetic beads (18) is preferably maintained. After about 1.5 min wash buffer P5 is unloaded through the first connector (7). It is possible to subsequently use different wash buffers. The selection of wash buffers and the number of wash steps depend on the particular analyte to be prepared, the binding material and sample solution used.

Afterwards, 100 μl elution buffer of the kit are loaded into the first chamber through the second connector (9), whereby no magnetic field is applied. Alternatively the elution buffer is loaded from a further chamber of the device. After incubating for 10 min at room temperature the magnetic beads are mixed with the elution buffer in the second chamber by repeatedly pushing the elution solution including the beads back and forth between the first and the second chamber while the magnetic field is inactivated. Then the magnetic field is applied for 5 min to collect all beads within one chamber and afterwards the eluate is dislodged through the first or second connector (7, 9). The amplification of the analyte, in particular DNA contained in the eluate, if required, can be carried out for instance with a light cycler PCR. Thereby the eluate can be submitted to a PCR without further steps required. Because of the sequence of wash steps the eluate is free of PCR inhibitors and amenable to PCR.

In summary, the method can be carried out in a simple and inexpensive way. The sample while sealed from the environment can be prepared in one single cassette, preferably a single use cassette. To carry out the method the solutions and/or the magnetic beads that are necessary for sample lysis washing, and for elution of the analytes contained in the sample various chambers can be provided in the cassette. In this case, only a predetermined sample volume has to be added. A contamination of the sample and/or the use of inappropriate concentrations of the solutions used for the lysis and the like are prevented. The eluate can be directly transferred to a PCR amplification/analysis device without further preparation and in particular in an automated way. This requires the further integration of a PCR functionality into the device. Therefore, it is possible to carry out the sample preparation and the analysis integrated in such a way, that laboratory personnel is only required for loading the sample.

### Example 6

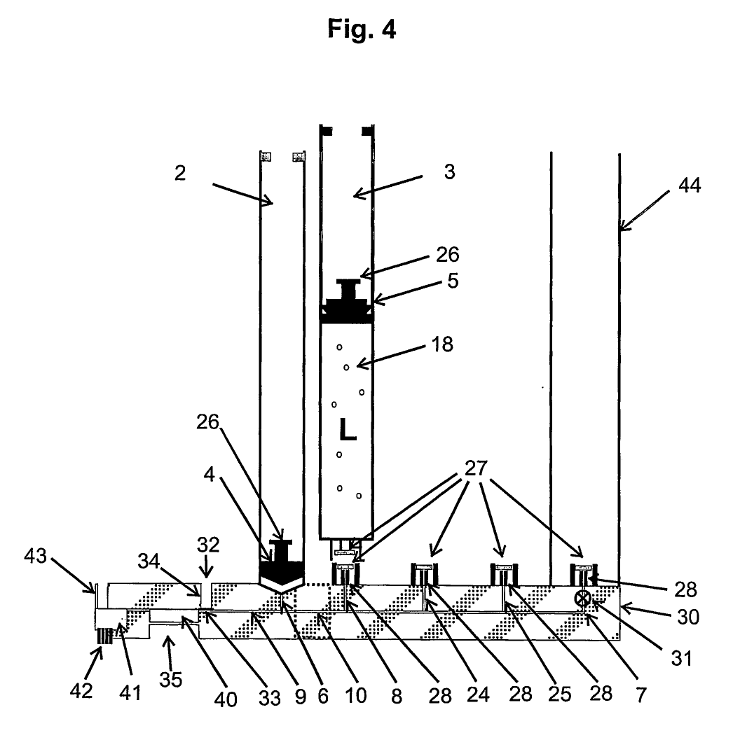

FIG. 4 shows a side view of a base plate (30) with a permanently attached chamber (2) and a detachable non-attached chamber (3). The base plate (30) comprises connectors (7, 9) through and channels for connection of the different chambers (3), which can be attached or are attached (2). The detachable chamber can be connected with the base plate. In the stadium depicted, i.e. the unassembled kit of parts stadium, the base plate, the permanently attached chamber and the attachable chamber are sealed towards the environment by the plunger (4, 5) and the seals (27). Both the seal on the chamber(s) and on the spike(s) (28) protruding from the base plate (30) will be broken once the chamber is engaged with the base plate. A sample can be loaded through the connector (7) when a syringe that is usually closed with a septum is attached to connector (7). To facilitate easy introduction of a syringe with a sample a guide (44) can be provided. The sample can be injected through anon-return valve or unidirectional restriction valve (31) which prevents efflux of any sample through the connector (7) once the syringe is removed. A removal of the syringe prior to the introduction of the device into the automated device with the hazard of releasing sample into the environment will be required, for example, if not all sample is applied to the device but if part of the sample is used for other purposes. A plunger (4) and (5) is provided both in the permanently attached chamber and in the detachable chamber. Both chambers are provided with a means for connecting with a movable rod, e.g. a snap-in device (26), which allows attaching the plunger to a rod that actuate the plunger in the chambers. The detachable chamber depicted comprises lysis solution (L) comprising magnetic beads (18).

A valve (32), which comprises a flexible membrane (33) and a cut out (34) through which the membrane can be actuated, is provided downstream of the sample preparation unit and separates this part of the device from the PCR amplification and detection unit. Further valves can be provided in a similar manner at any desired point on the base plate. Preferably a further valve (32) is provided between channels (6, 8, 10) and channels (24, 25) to separate the reaction/mixing chambers (2, 3) from the reagent storage chambers (20, 21 not shown here).

Once the analyte, in particular DNA has been prepared and eluted from the beads it can be dislodged through connector (9) into the PCR chamber (40) through the open valve (32). A further valve (32) can be provided downstream of the PCR chamber (40) to separate it from the detection chamber (41). The PCR chamber (40) is further provided with a cut out (35) in the base plate, which allows close contact between a heating device or hot air and the PCR chamber to affect efficient cycling of the temperature as required during the PCR process. Any further reagents required by the PCR or the detection of analyte are supplied from additional chambers (29) attached or attachable to the base plate (30) which are not depicted here. If mixing is required this can be carried out within the additional chambers (29) or within specialized mixing channels not depicted here like, for example, meandering channels. The detection chamber (41) comprises in a preferred embodiment pin-electrodes (42) protruding into the chamber to which analyte binding substances are attached. The binding of the analyte to the analyte binding substances will then be detected electrochemically. Any waste liquid like, for example, hybridization buffer which is discarded after hybridization or wash buffer can be discarded through channel (43) into the waste chamber (45) not depicted here.

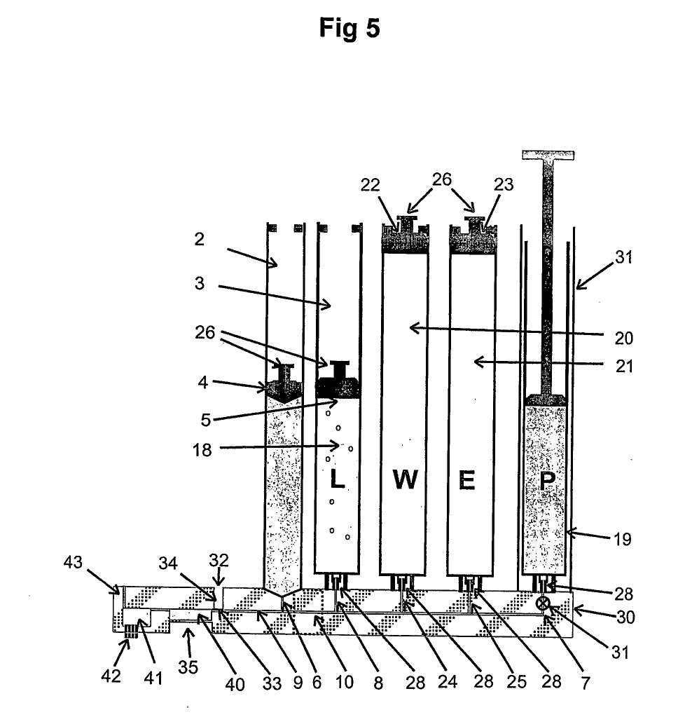

FIG. 5 depicts the same device as FIG. 4, however, three detachable chambers (3, 20, 21) have been attached to the base plate and are now in fluidic connection with the other chambers through their respective channels (8, 24, 25). The spike has broken the seal, whereby excess of the different reactants (L, W, E) to the channels is allowed. Once all chambers are attached in an initial step air will be purged from the system by flowing some of the buffer through the system. A syringe (19) comprising analyte containing sample is attached to the connector (7) and a septum on the syringe is pierced by the spike (28) and the sample (P) is injected into chamber (2). In most cases the amount of sample injected into chamber (2) will be chosen in such that the sample once mixed with lysis buffer (L) comprising beads (18) fits completely into either chamber (2) or chamber (3). This allows to almost completely move the sample solution back in forth between chamber (2) and (3).

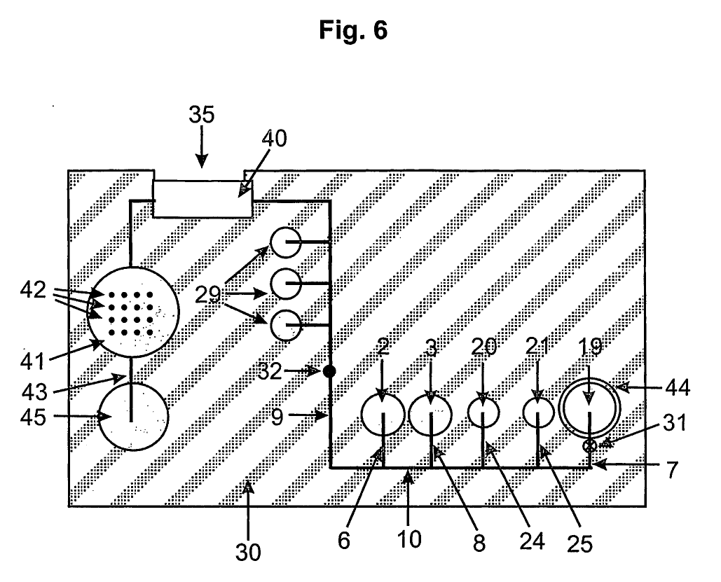

FIG. 6 shows a top view of the base plate and also shows additional chambers (29) comprising reagents for the PCR reaction which is performed in the PCR chamber (40). The detection chamber (41) holds a grid of 16 pin-electrodes (42) to which various analyte binding molecules have been attached. Any solution which needs to be discarded from the detection chamber is discarded through channel (43) into the waste chamber (45).

1. A device for contamination free preparation of analyte containing sample solution (P) comprising
a first (2) and second chamber (3), which are connected by a channel (6, 8, 10)
wherein the first chamber (2) has means (4) for reversibly changing its volume, and the second chamber (3) has a reversibly changeable volume,
wherein a connector (7, 9), which is provided with a means of flow regulation, is connected to the channel (6, 8, 10) or one of the chambers (2, 3) for loading of a sample solution into the first (2) or the second chamber (3),
characterized in that
there is provided at least one further chamber (15, 20, 21) being filled with a reactant and sealed, the further chamber being connectable to the channel (6, 8, 10) prior to use.

2. The device of claim 1, wherein the chambers (2, 3) and the channel (6, 8, 10) are designed as a single use device.

3. The device of claims 1, wherein no means of flow regulation is provided between the first (2) and the second chamber (3).

4. The device of claim 1, wherein the sec and chamber is provided with a means f or reversibly changing the volume.

5. The device of claim 1, wherein a first connector (7) is connected either to a first channel (6) which extends from an end of the first chamber (2) opposite the first means (4) for reversibly changing the volume of the first chamber (2) or to the first chamber (2).

6. The device of claim 1, wherein a second connector (9) is connected to a second channel (8), which ex tends from an end of the second chamber opposite the second means (5) for reversibly changing the volume or to the second chamber (3).

7. The device of claim 1, wherein a second channel (8) extends from an end of the second cylinder opposite the second piston (5), wherein the channel (8) is connected to the first channel (6) or the first chamber (2).

8. The device of claim 1, wherein the further chamber (15, 20, 21) has a reversibly changeable volume, preferably a means for reversibly changing the volume and wherein that chamber(s) is (are) connected with the first (2) and/or second chamber (3) through the first (6) or second channel (8) or through a further channel(s) (17, 24, 25), which is (are) connected to a third channel (10) connecting the first (6) and second channel (8).

9. The device of claim 1, wherein a means of flow regulation is provided between the first (2) and the second chamber (3) on one side and at least one further chamber(s) (15, 20, 21) on the other side.

10. The device of claim 1, wherein at least one channel between two of the further chambers (15, 20, 21) has a volume larger than the total compressible volume of the system.

11. The device of claim 1, wherein at least one of the chambers are conically tapered at the end of the chamber opposite the means (4, 5, 14, 22, 23) for reversibly changing the volume with the opening of the respective channels (6, 8, 17, 24, 25) located at the tip of the conus.

12. The device of claim 1, wherein the means for changing the volume in the first (2), second (3) and/or further chamber(s) (15, 20, 21) is a piston (4, 5, 14, 10 22, 23).

13. The device of claim 12, wherein the piston(s) have the shape of the end of the chamber opposite to them or can accommodate this shape.

14. The device of claim 12, wherein the pistons (4, 5) of the first (2) and/or the second chamber (3) comprise an elastic material, which has or can accommodate the shape of the end of the chamber opposite to them.

15. The device of claim 12, wherein the pistons (16, 22, 23) in further chambers (15, 20, 21) comprise a reduced elasticity in comparison to the pistons (4, 5) in the first chamber (2) and/or second chamber (3).

16. The device of claim 12, wherein the pistons (16, 22, 23) are not connected to a piston rod.

17. The device of claim 1, wherein the chambers (2, 3, 15, 20, 21) have an essentially round cross-section.

18. The device of claim 1, wherein at least one chamber (2, 3, 15, 20, 21) preferably at least the second (3) and/or the further chamber(s) (15, 20, 21) are connectible to the channel(s) (8, 17, 24, 25).

19. The device of claim 1, wherein the axes of the chambers (2, 3, 15, 20, 21) are arranged parallel to each other.

20. The device of claim 1, wherein in one of the chambers (2, 3, 15, 20, 21), preferably in the second chamber (3) a liquid CL) is provided capable of solubilizing organic substances comprising an analyte and wherein the organic substances are preferably cells.

21. The device of claim 1, wherein in at. least one of the chambers (2, 3, 15, 20, 21) or in at least one of the channel(s) (6, 8, 10, 17, 24, 25) magnetic particles (18) are provided capable of binding the analyte.

22. The device of claim 21, wherein the magnetic particles (18) have a diameter in the range from 50 nm to 50 μm, preferably from 200 nm to 201 μm.

23. The device of claim 1, wherein in one of the chambers (2, 3, 15, 20, 21), preferably in a further chamber (20), a wash solution (W) is provided.

24. The device of claim 1, wherein in one of the chambers (2, 3, 15, 20, 21), preferably in a further chamber (21), an elution solution (E) is provided.

25. The device of claim 1, wherein the connectors (7, 9) are provided with a means of flow regulation, preferably a valve or septum.

26. The device of claim 1, wherein the chambers (2, 3, 15, 20, 21) are fluid tight against the surrounding when the connector(s) (7, 9) are closed.

27. The device of claim 1, equipped to accommodate the positioning of a magnet at the end of the chamber(s) (2, 3, 15, 20, 21), preferably the first (2) or the second chamber (3).

28. The device of claim 1, wherein the de vice is provided with an enclosure (1) and wherein the enclosure (1) is preferably made of synthetic material.

29. The device of claim 1 wherein the channels (6, 8, 17, 24, 25) and the connectors (7, 9) are comprised in a base plate (30).

30. The device of claim 29, wherein at least the first chamber, preferably all chambers (2, 3, 15, 20, 21) open up towards the edge of the enclosure (1), so that the means (4, 5, 14, 22, 23) for reversibly changing the volume can be operated from the outside.

31. The device of claim 29, wherein the enclosure (1) and/or the base plate (30) provided with a means (13) for attaching the device in a corresponding receptacle to allow automatic changing of the volume of at least one chamber (2, 3, 15, 20, 21).

32. A kit of parts comprising a base plate comprising a channel (6, 8, 10), wherein a connector (7, 9), which is provided with a means of flow regulation, is connected to the channel (6, 8, 10) and at least one at least one chamber (15, 20, 21) being filled with a reactant and sealed, the chamber (15, 20, 21) being connectable to the channel (6, 8, 10) prior to use.

33. A method for contamination free preparation of analyte(s) from organic substance comprised in a sample solution (P), using a device according to claim 1 comprising the following steps:
introducing a predetermined volume of sample solution (P) through a connector (7, 9) into the first (2) or second chamber (3),
interrupting the flow directed through the connector (7, 9),
moving back and forth of the sample solution (P) between the first (2) and the second (3) chamber in such that the sample solution is contacted with material binding or adsorbing the analyte and that the analyte(s) comprised in the sample solution (P) can bind or adsorb to the material, and
dislodging of the analyte(s) through a connector (7, 9).

34. The method of claim 33 comprising the following step: optionally eluting the analyte from said material.

35. The method of claim 33, wherein the analyte is selected from the group consisting of nucleic acids and polypeptides.

36. The method of claim 33, wherein the material binding or adsorbing the analyte coats at least part of the surface of the chambers (2, 3, 15, 20, 21) and/or channels 30 (6, 8, 17, 24, 25) or particles, in particular magnetic particles comprised within the chambers and/or channels.

37. The method of claim 36, wherein the analyte(s) is (are) dislodged bound to the magnetic particles (18) or separate from the magnetic particles (18).

38. The method of claim 33, wherein the sample solution (P) is moved back and forth by alternately extending and reducing the volume of the first chamber (2).

39. The method of claim 33, wherein the sample solution (P) is moved back and forth by alternately moving the first (4) and the second means (5) for reversibly changing the volume towards the end of the chamber opposite to the means (4, 5).

40. The method of claim 33, wherein the sample solution (P) is in a further step sonicated and/or mixed with a liquid (L) for solubilization of the organic sub stance comprised in the sample solution (P).

41. The method of claim 36, wherein the magnetic particles (18) and the analyte bound thereon are retained in a predetermined region of a chamber (2, 3), preferably the end of the first (2) or second chamber (3) opposite to the means for reversibly changing the volume (4, 5) by generating a magnetic field in the predetermined region of the chamber (2, 3).

42. The method of claim 33, wherein in a further step sample solution (P) depleted of analyte(s) is substantially removed from the chamber(s) (2, 3).

43. The method of claim 33, wherein a wash solution (W) provided in one further chamber (20) is flown over surface coated with binding material or mixed with the particles, preferably magnetic particles (18).

44. The method of claim 43, wherein the magnetic particles (18) and the analyte bound thereon are retained in a predetermined region of a chamber, preferably the end of the first (2) or second chamber (3) opposite to the means for reversibly changing the volume (4, 5) by generating a magnetic field in the predetermined region of the chamber (2,3).

45. The method of claim 43, wherein in a further step S wash solution (W) is substantially removed from the chamber(s) (2, 3).

46. The method of claim 33, wherein an elution solution (E) provided in one further chamber (21) flown over surface coated with binding material or mixed with the particles, preferably magnetic particles (18).

47. A method according to claim 46, wherein the magnetic particles (18) are retained in a predetermined region of a chamber, preferably the end of the first (2) or second chamber (3) opposite to the means for reversibly changing the volume (4, 5) by generating a magnetic field in the predetermined region of the chamber.

48. The method of claim 46, wherein in a further step elution solution (E) comprising the analyte is substantially dislodged from the chamber (2, 3).

49. The method of claim 46, wherein the elution volume is in a range from about 1 to about 100 μl.

50. The method of claim 33, wherein the sample solution (P) depleted of analyte, the liquid (L) for solubilization mixed with the sample solution (P) depleted of analyte, the wash solution (W) and/or the magnetic particles (18) are collected in one of the chambers (2, 3, 15) and are discarded after dislodging, preferably together with the enclosure (1).

51. The method of claim 33, wherein the flow of liquids between two chambers (2, 3, 15, 20, 21) is controlled by alternately extending and reducing the volume of one chamber (2, 3, 15, 20, 21), while keeping the volume of all but one of the other chambers (2, 3, 15, 20, 21) constant.

52. The method of claim 33, wherein the flow of liquids between two chambers (2, 3, 15, 20, 21) is controlled by alternately moving one means (4, 5, 14, 22, 23) and a second means (4, 5, 14, 22, 23) for reversibly changing the volume towards the end of the chamber (2, 3, 15, 20, 21) opposite to the means, while keeping the volume of all other chambers (2, 3, 15, 20, 21) constant.

53. A method according to claim 33, wherein no further liquid except the sample solution (P) is introduced into the system formed by the chambers (2, 3, 15, 20, 21) and the channels (6, 8, 10, 17, 24, 25).
